(19) United States
(12) Patent Application Publication
(10) Pub. No.: US 2026/0138021 A1
(43) Pub. Date: May 21, 2026

(54) COMPUTER-READABLE STORAGE MEDIA, GAME PROCESSING METHOD, AND GAME SYSTEM

(71) Applicant: NINTENDO CO., LTD., Kyoto (JP)

(72) Inventors: Yusuke KITAZONO, Kyoto (JP); Yosuke MORI, Kyoto (JP); Hayato ICHINO, Kyoto (JP); Ryo KAWASAKI, Kyoto (JP); Eisaku SATO, Tokyo (JP)

(21) Appl. No.: 19/389,349

(22) Filed: Nov. 14, 2025

(30) Foreign Application Priority Data
Nov. 20, 2024 (JP) 2024-202072

(51) Int. Cl. A63F 13/55; G06T 17/20

(52) U.S. Cl. CPC A63F 13/55; G06T 17/20

(57) ABSTRACT

Second voxel data in which the same material as a material determined based on a positional relationship with respect to a position where a first action has been performed is set, and a second mesh that is a mesh of a second voxel object related to the second voxel data, and for which vertex coordinates of the mesh are determined based on at least a density, and a material of the mesh is determined based on the material of the second voxel data, are generated. When the material of the second voxel data is a first material, a first in-game effect related to the first material is produced for the second voxel object, and a size of the second voxel object is reduced according to game progression.

### CROSS REFERENCE TO RELATED APPLICATION

This application claims priority to Japanese Patent Application No. 2024-202072, filed on Nov. 20, 2024, the entire contents of which are incorporated herein by reference.

### FIELD

The technology disclosed herein relates to computer-readable storage media, game processing methods, and game systems that generate an object in a virtual space using voxel data.

### BACKGROUND AND SUMMARY

A technique of generating a mesh based on voxel data has conventionally been proposed.

It is considered that in the case in which a game in which the voxel mesh generation technique is used is provided, it is necessary to utilize a material included in voxel data.

The present example discloses computer-readable storage media, game processing method, and game system capable of further utilizing a material included in voxel data in a game.

The present example may have the following features (1) to (16), for example.

(1) An example configuration of one or more non-transitory computer-readable storage media according to the present example is one or more non-transitory computer-readable storage media having stored therein instructions that, when executed, cause one or more processors to perform operations comprising: generating and updating a first mesh based on first voxel data defined in a virtual space, wherein the first mesh is a mesh of a first voxel object related to the first voxel data, wherein in the first voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material; controlling a player character in the virtual space based on an operation input, and in response to a first instruction based on an operation input, causing the player character to perform a first action, reducing the densities of voxels of the first voxel data related to a first voxel update range set based on a position where the first action has been performed, and generating second voxel data and a second mesh, wherein, for each voxel, the density and the material are set in the second voxel data, and the material of the voxel is set, in the second voxel data, to the same material as one of materials of voxels of the first voxel data or the first mesh that is determined based on a positional relationship with respect to the position where the first action has been performed, and wherein the second mesh is a mesh of a second voxel object related to the second voxel data, vertex coordinates of the mesh of the second voxel object are determined based on at least the density, and a material of the mesh of the second voxel object is determined based on the material of the second voxel data; when the material of the second voxel data is a first material, generating a first in-game effect related to the first material for the second voxel object, and reducing a size of the second voxel object according to game progression; and rendering the virtual space including the first mesh and the second mesh.

With the configuration of (1), a player character can be caused to perform the first action of generating the second voxel object from the first voxel object, and the first in-game effect that occurs due to consumption of the second voxel object can be produced based on the material of the second voxel object. Therefore, a material in voxel data can be further utilized in a game.

(2) In the configuration of (1), the first voxel data may define in a first voxel space. The second voxel data may be defined in a second voxel space. In that case, the operations may further comprise: reducing the size of the second voxel object by reducing a size in the virtual space of the second voxel space.

With the configuration of (2), the size of the second voxel object can be reduced by reducing the entire voxel space.

(3) In the configuration of (1), the operations may further comprise: setting a second voxel update range at a position in the virtual space based on a position of the first voxel object, and reducing the size of the second voxel object by reducing the densities of voxels in the second voxel data related to the second voxel update range.

With the configuration of (3), the size of the second voxel object can be reduced by reducing the densities of a portion of the voxels of the second voxel object.

(4) In the configuration of (1), the operations may further comprise: reducing the size of the second voxel object with the passage of time during which the first in-game effect is produced.

With the configuration of (4), the first in-game effect can be limited based on the passage of time during which the first in-game effect is produced.

(5) In the configuration of (1), the operations may further comprise: reducing the size of the second voxel object each time the first in-game effect is produced.

With the configuration of (5), the first in-game effect can be limited to the case in which the first in-game effect is produced.

(6) In the configuration of (4) or (5), the first voxel data may be defined in a first voxel space. The second voxel data may be defined in a second voxel space. In that case, the operations may further comprise: reducing the size of the second voxel object by reducing a size in the virtual space of the second voxel space.

With the configuration of (6), the size of the second voxel object can be reduced by reducing the entire voxel space.

(7) In the configuration of any one of (4) to (6), the operations may further comprise: setting a second voxel update range at a position in the virtual space based on a position of the first voxel object, and reducing the size of the second voxel object by reducing the densities of voxels in the second voxel data related to the second voxel update range.

With the configuration of (7), the size of the second voxel object can be reduced by reducing the densities of a portion of the voxels of the second voxel object.

(8) In the configuration of any one of (1) to (5), the operations may further comprise: when the size of the second voxel object is smaller than a reference, deleting the second voxel object and ending the first in-game effect.

With the configuration of (8), the first in-game effect can be limited by reducing the size of the second voxel object.

(9) In the configuration of any one of (1) to (5), the operations may further comprise: causing the player character to perform an action of holding the second voxel object and an action of releasing the second voxel object according to a second instruction based on an operation input; and when the player character is holding the second voxel object, producing the first in-game effect.

With the configuration of (9), the first in-game effect can be produced only when a player character is holding the second voxel object.

(10) In the configuration of (9), the operations may further comprise: controlling movement of the player character based on virtual gravity toward a downward direction in the virtual space; and when the player character is holding the second voxel object, causing the player character to move in an upward direction in the virtual space as the first in-game effect.

With the configuration of (10), the effect of causing a player character to move upward in the virtual space can be produced for a player character.

(11) In the configuration of (9), the operations may further comprise: when the player character is holding the second voxel object, causing the player character to move on a path set in the virtual space as the first in-game effect.

With the configuration of (11), the effect of causing a player character to move on a predetermined path set in the virtual space can be produced for a player character.

(12) In the configuration of (9), the operations may further comprise: when the player character is sitting on the second voxel object, causing the player character to move on the first object, based on an operation input, as the first in-game effect.

With the configuration of (12), the effect of causing a player character to move on the first object while sitting on the second voxel object can be produced for a player character.

(13) In the configuration of (9), the material may have a hardness depending on the type of the material. In that case, the operations may further comprise: causing the player character to move along with the second voxel object, and reducing the size of the second voxel object based on the hardness of the material of the second voxel object and a movement distance of the second voxel object, as the first in-game effect.

With the configuration of (13), the period of time during which the first in-game effect is produced can be changed, depending on the hardness of the material of the second voxel object.

(14) In the configuration of any one of (1) to (5), the operations may further comprise: setting a light source at a position of the second voxel object in the virtual space as the first in-game effect.

With the configuration of (14), the effect of providing a light source at the position of the second voxel object in the virtual space can be produced.

(15) In the configuration of any one of (1) to (5), the operations may further comprise: when materials of voxels in the first voxel data related to a third voxel update range including a position of the second voxel object are a second material, changing the materials to a third material.

With the configuration of (15), the effect of changing the material of the first voxel object in the virtual space can be produced.

(16) In the configuration of any one of (1) to (5), the first mesh may include a display mesh used for rendering and a determination mesh used for collision determination. A material of the display mesh may be set by setting at least one material for each polygon of the mesh, based on the materials of the voxels around each vertex of the polygon. A material of the determination mesh may be set by setting a material for each polygon of the mesh, based on the materials of the voxels around each vertex of the polygon. In that case, the operations may further comprise: setting the same material as that which is set for a polygon at a collision position, as the material of the second voxel data, based on collision determination between a collision shape set based on the position where the first action has been performed and the determination mesh of the first mesh; and rendering the first mesh by rendering the display mesh based on vertex coordinates of the display mesh and a texture associated with the material of each polygon of the display mesh.

With the configuration of (16), the determination mesh and the display mesh are determined separately. Therefore, appropriate meshes can be used for respective purposes.

Furthermore, the present example may be carried out in forms of a game processing method and a game system.

According to the present example, an in-game effect that occurs due to consumption of a voxel object can be produced based on a material of the voxel object. Therefore, a material in voxel data can be further utilized in a game.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a view showing a non-limiting example where a left controller and a right controller are attached to a main body apparatus;

FIG. 2 is a view showing a non-limiting example where a left controller and a right controller are removed from a main body apparatus;

FIG. 3 is a six-sided view showing a non-limiting example of a main body apparatus;

FIG. 4 is a six-sided view showing a non-limiting example of a left controller;

FIG. 5 is a six-sided view showing a non-limiting example of a right controller;

FIG. 6 is a block diagram showing a non-limiting example of an internal configuration of a main body apparatus;

FIG. 7 is a block diagram showing a non-limiting example of an internal configuration of a main body apparatus, a left controller and a right controller;

FIG. 8 is a view showing a non-limiting example of a terrain object, which is a voxel object;

FIG. 9 is a view showing a non-limiting example of a state before and after the deletion of a portion of the terrain object shown in FIG. 8;

FIG. 10 is a view showing a non-limiting example of states before and after the deletion of a portion of the terrain object shown in FIG. 8;

FIG. 11 is a view showing a non-limiting example of voxel data;

FIG. 12 is a view showing a non-limiting example of material data;

FIG. 13 is a view showing a non-limiting example of a game space when an update event has occurred;

FIG. 14 is a view showing a non-limiting example of an update range;

FIG. 15 is a view showing a non-limiting example of a method for setting vertices;

FIG. 16 is a view showing a non-limiting example of a method for determining a material of a vertex;

FIG. 17 is a view showing a non-limiting example of vertex simplification;

FIG. 18 is a view showing a non-limiting example of conditions regarding materials;

FIG. 19 is a view showing a non-limiting example of a mesh generated based on vertices;

FIG. 20 is a view showing a non-limiting example of division of a quadrangle forming a mesh into two triangles;

FIG. 21 is a view showing a non-limiting example of a method for determining materials of polygons forming a display mesh;

FIG. 22 is a view showing a non-limiting example of materials set for vertices of adjacent two polygons;

FIG. 23 is a view showing a non-limiting example of application of textures to polygons;

FIG. 24 is a view showing a non-limiting example of a method for determining materials of polygons forming a determination mesh;

FIG. 25 is a diagram showing a non-limiting example of a game image representing a state in which a player character moves on a terrain object;

FIG. 26 is a diagram showing a non-limiting example of a game image representing a state in which a player character 201 pulls a fragment object 252 out of a terrain object 202;

FIG. 27 is a diagram showing a non-limiting example of a game image representing a state in which a fragment object is generated by the player character 201 destroying the terrain object 202;

FIG. 28 is a diagram showing a non-limiting example of a game image representing a state in which a player character 201 performs a flying action while holding a fragment object 256, in a game space;

FIG. 29 is an explanatory diagram showing a non-limiting example in which the size of a fragment object 256 is reduced;

FIG. 30 is a diagram showing a non-limiting example of a game image representing a state in which a player character 201 performs a gliding action along a wire rope 301 provided in a game space while holding a fragment object 257;

FIG. 31 is a diagram showing a non-limiting example of a game image representing a state in which a player character 201 performs a moving action while sitting on a fragment object 258, in a game space;

FIG. 32 is an explanatory diagram showing a non-limiting example in which the size of the fragment object 258 is reduced;

FIG. 33 is a diagram showing a non-limiting example of a game image representing a state in which a player character 201 performs an action of illuminating a game space with light while holding a fragment object 261;

FIG. 34 is a diagram showing a non-limiting example of a game image representing a state in which a player character 201 performs an action of illuminating a game space with light by a fragment object 261 thrown by the player character 201;

FIG. 35 is a diagram showing a non-limiting example of a game image representing a state in which a player character 201 throws a fragment object 263 into a region 251 of a terrain object;

FIG. 36 is a diagram showing a non-limiting example of a game image after a terrain object has been changed due to contact of a fragment object 263 with the region 251 of the terrain object shown in FIG. 35;

FIG. 37 is a diagram showing a non-limiting example of a game image after the terrain object has been changed due to additional contact of the fragment object 263 with the region 251 of the terrain object shown in FIG. 36;

FIG. 38 is a diagram showing a non-limiting example of a game image representing a state in which a player character 201 performs an action of moving into a region 251 of a terrain object while sitting on a fragment object 263, in a game space;

FIG. 39 is a view showing a non-limiting example of various data used for information processing in a game system;

FIG. 40 is a flowchart showing a non-limiting example of a flow of game processing executed by a game system; and

FIG. 41 is a subroutine showing a non-limiting example of an in-game effect process in step S7 of FIG. 40.

### DETAILED DESCRIPTION OF NON-LIMITING EXAMPLE EMBODIMENTS

### [1. Configuration of Game System]

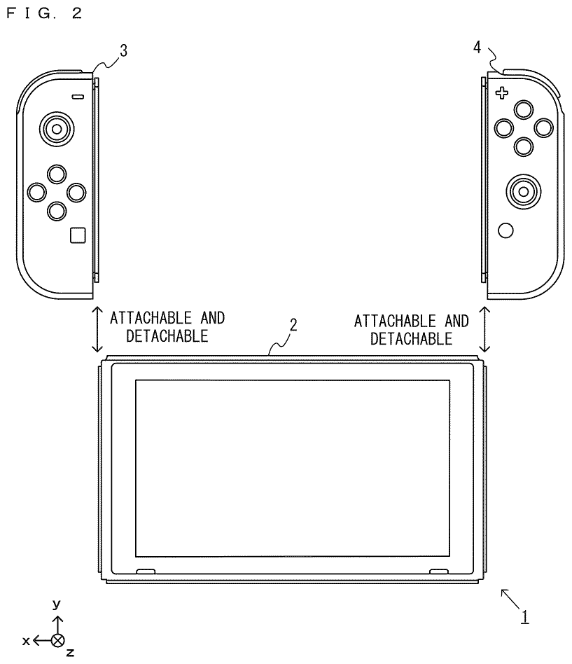

A game system according to the present example is described below. An example of a game system 1 according to the present example includes a main body apparatus (an information processing apparatus; which functions as a game apparatus main body in the present example) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the present example is described, and then, the control of the game system 1 according to the present example is described.

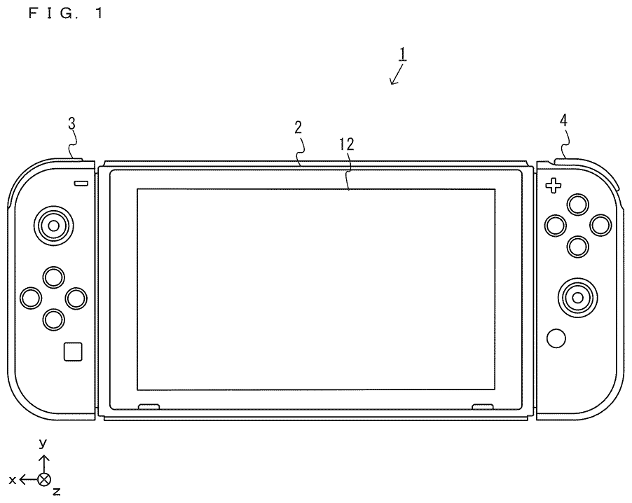

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

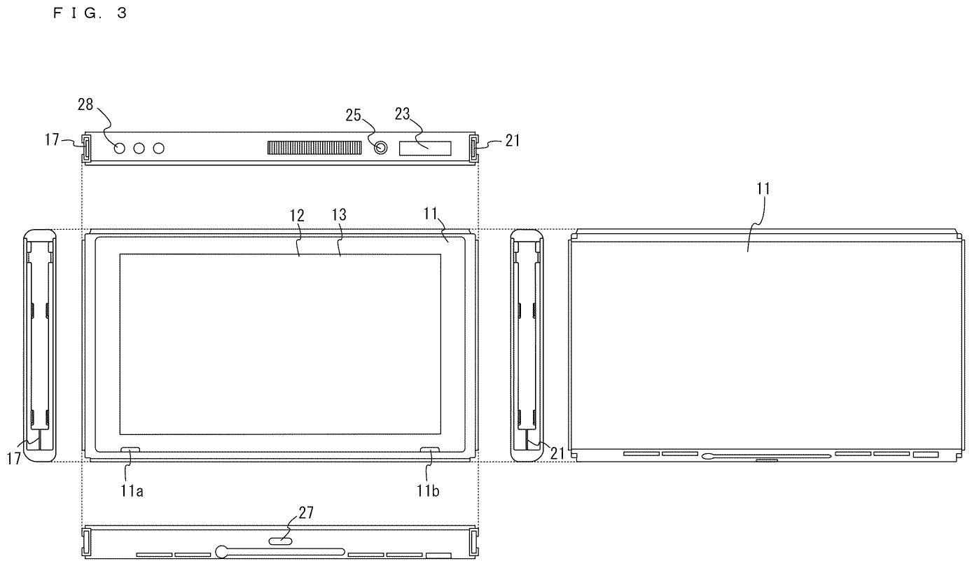

FIG. 3 is six orthogonal views showing an example of the main body apparatus 2. As shown in FIG. 3, the main body apparatus 2 includes an approximately plate-shaped housing 11. In the present example, a main surface (e.g., a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any type.

Further, the main body apparatus 2 includes a touch panel 13 on a screen of the display 12. In the present example, the touch panel 13 is of a type that allows a multi-touch input (e.g., a capacitive type). The touch panel 13, however, may be of any type. For example, the touch panel 13 may be of a type that allows a single-touch input (e.g., a resistive type).

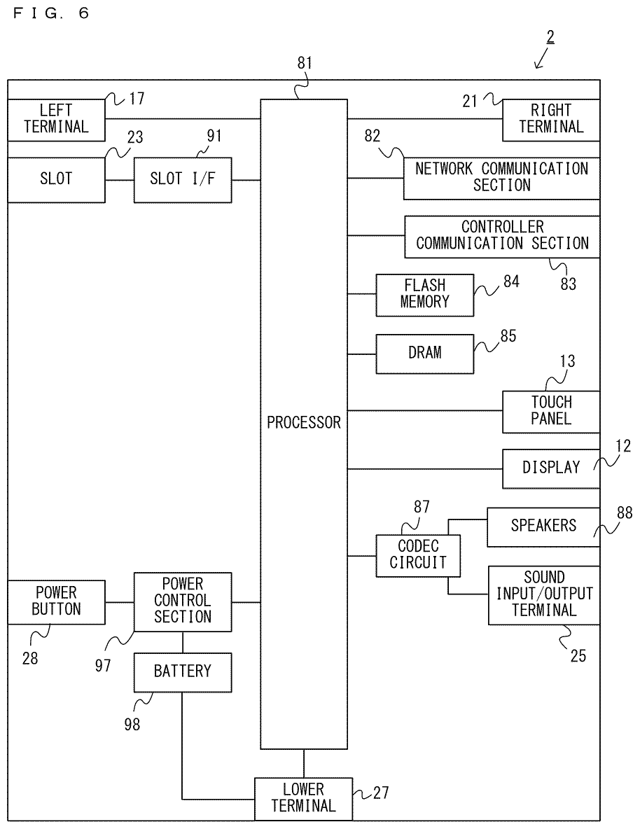

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the present example, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the present example, the cradle has the function of charging the unified apparatus or the main body apparatus 2 alone mounted on the cradle. Further, the cradle has the function of a hub device (specifically, a USB hub).

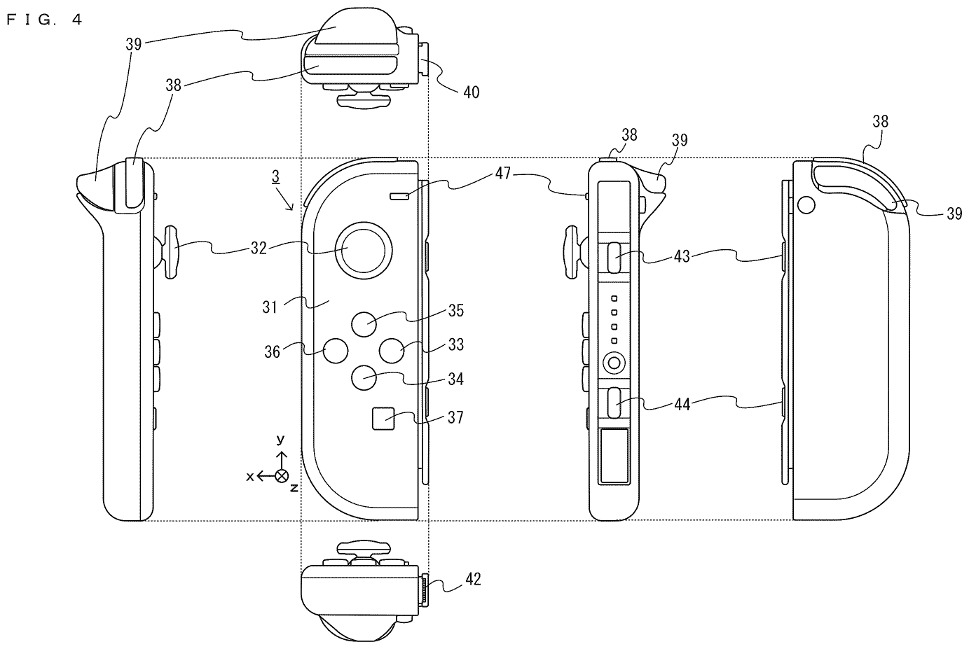

FIG. 4 is six orthogonal views showing an example of the left controller 3. As shown in FIG. 4, the left controller 3 includes a housing 31. In the present example, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

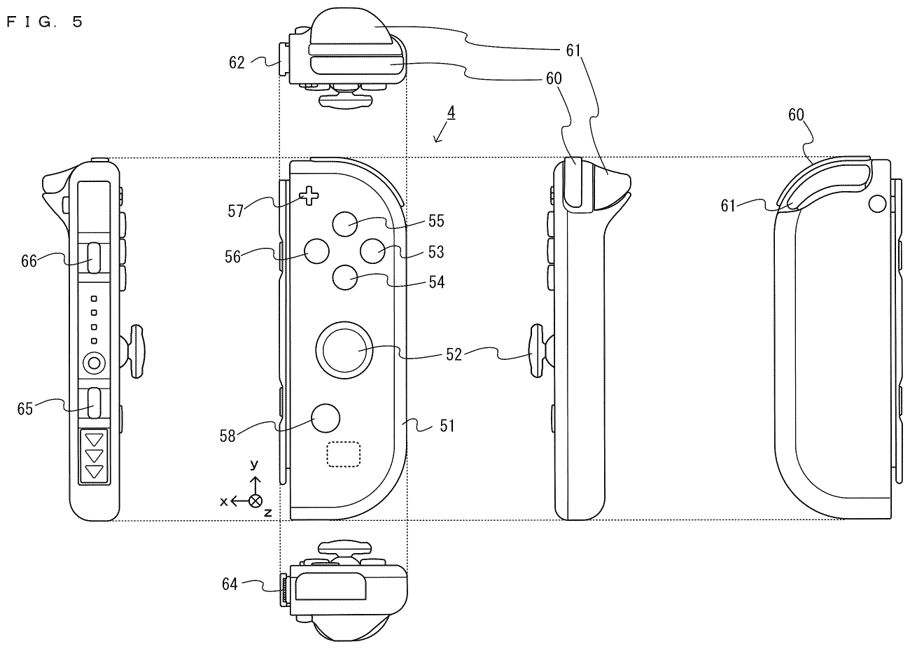

FIG. 5 is six orthogonal views showing an example of the right controller 4. As shown in FIG. 5, the right controller 4 includes a housing 51. In the present example, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi (registered trademark) standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the present example, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the present example, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

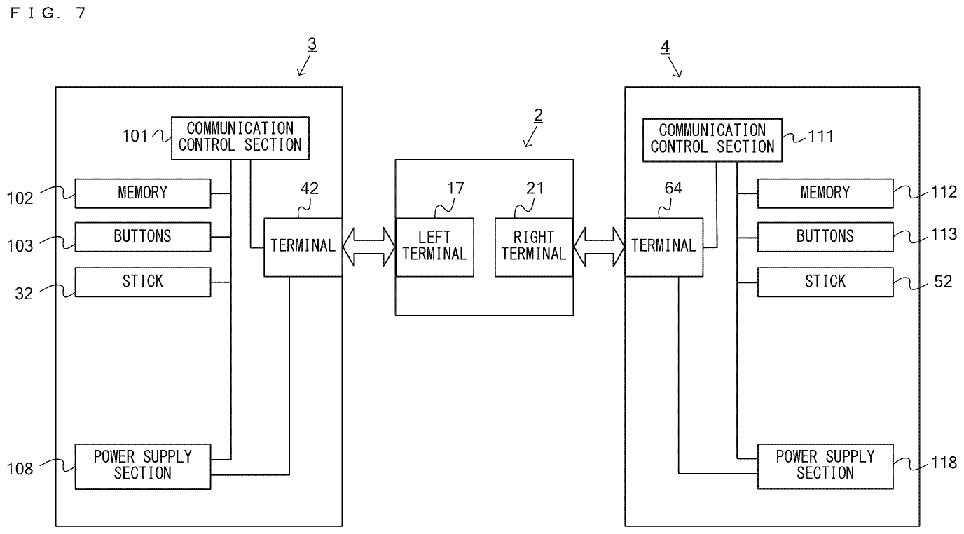

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the present example, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

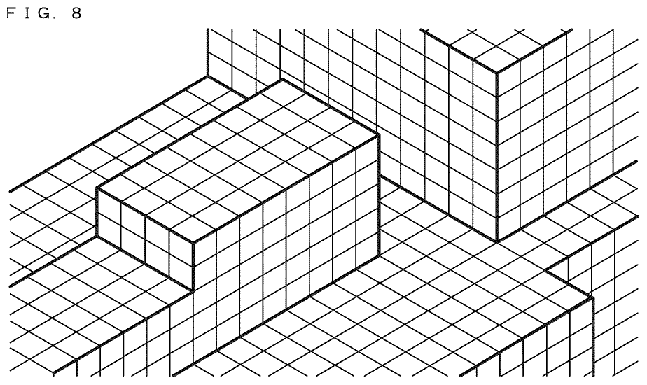

Next, referring to FIGS. 8 to 38, an outline of the process performed on the game system 1 will be described. In the present example, the game system 1 generates a game image in which terrain objects and characters (e.g., the player character controlled by the player) are arranged in a game space, which is a three-dimensional virtual space, and displays the game image on a display device. Note that in the present example, the display device on which the game image is displayed may be the display 12 described above, or may be a stationary monitor.

### [2-1. Voxel]

In the present example, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present example, the game system 1 stores voxel data for a plurality of voxels that are set in the game space as data for generating voxel objects in the game space.

FIG. 8 is a view showing an example of a terrain object, which is a voxel object.

As shown in FIG. 8, in the present example, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

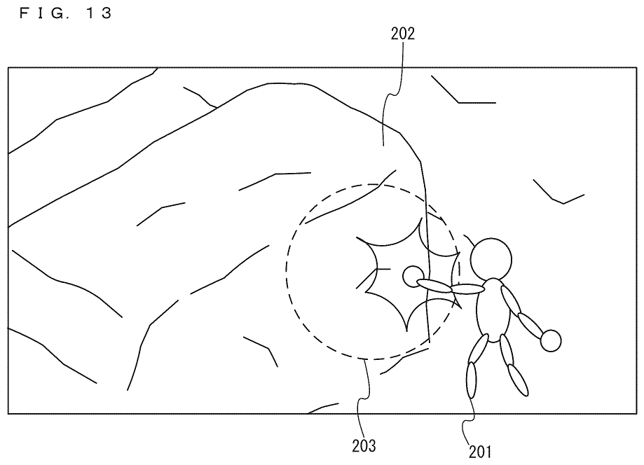

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present example, in practice, a voxel object is generated (e.g., based on voxel data) by such a rule that results in a terrain object having a complicated shape, such as a terrain object shown in FIG. 13 to be described below, for example. Note that there is no limitation on the rule for determining the shape of the voxel object based on the voxel data. In other examples, the game system 1 may generate a voxel object as shown in FIG. 8 based on the object data or may generate a voxel object as shown in FIG. 13 based on the object data.

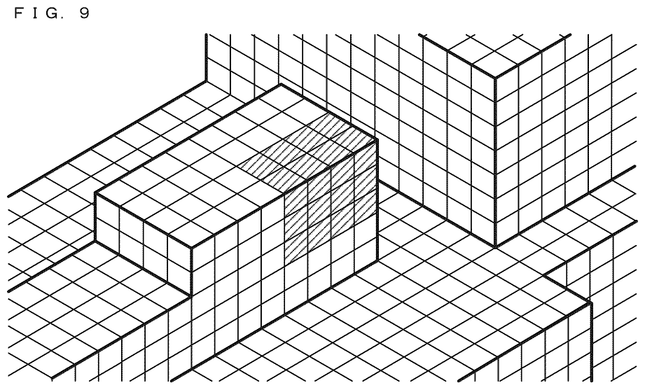

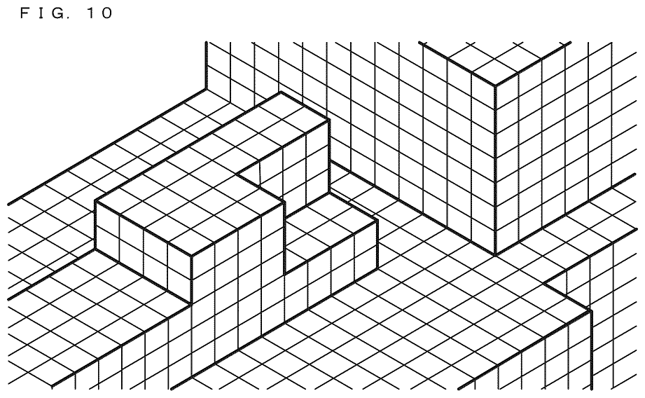

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the present example, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a main voxel space that is set over the entire game space, and a sub voxel space that is set in a certain area in the game space. In this case, the game system 1 stores therein the voxel data for each voxel space.

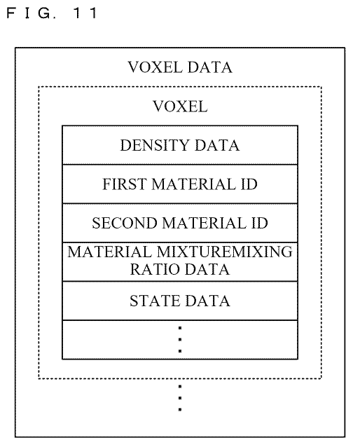

FIG. 11 shows an example of voxel data. The voxel data includes density data, a first material ID, a second material ID, material mixing ratio data, and state data, for each voxel defined in the game space. In the voxel data according to the present example, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the present example, the density can take an integer value within a range from a lower limit value (e.g., 0) to an upper limit value (e.g., 255). In the present example, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 8 and the method for generating a voxel object as shown in FIG. 13 even if these methods are based on the same density.

In other examples, the density may indicate either a state in which the volume of the area in the voxel object occupies the entire area in the voxel or a state in which the volume of the area in the voxel object is not included in the area in the voxel. For example, the density data may be data that can take only 0 or 1.

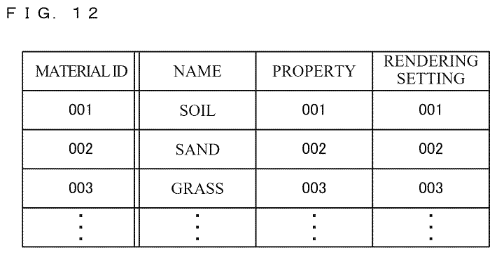

The first material ID and the second material ID are information indicating materials of the corresponding voxel. In the present example, a material such as sand, rock, or soil is set for a voxel. In the game system 1, multiple types of materials are prepared as materials that can be set for voxels (see material data shown in FIG. 12). In the present example, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the present example, the voxel data includes the ID indicating the material. However, in other examples, the voxel data may have a data structure that includes data directly indicating the details of the material (e.g., information on the name, property, and rendering setting described below).

The material mixing ratio data is an example of data indicating a ratio of materials in the voxel. In the present example, since at most two material IDs are set for one voxel, the material mixing ratio data, which indicates the ratio of one of the material indicated by the first material ID and the material indicated by the second material ID, can also indicate the ratio of the other material. In the present example, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other examples, the material mixing ratio may be a value indicating the proportion of the first material. The ratio of the materials in the voxel may be indicated by the values of the proportions of the materials. In particular, in other examples, if the number of settable types of materials is not limited to two at most and three or more types of materials can be set, the ratio of the materials in the voxel is indicated by a plurality of values respectively indicating the proportions of the materials.

In the present example, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the present example, the state data includes data indicating the amount of damage set on the voxel. In other examples, the state data may include data indicating whether or not the voxel is wet (and its extent), for example.

As described above, in the present example, since the voxel data includes the material ID, the game system 1 stores therein material data that defines the content of the material indicated by the material ID. FIG. 12 shows an example of the material data. As shown in FIG. 12, in the material data according to the present example, for each material, a material ID is associated with information about a name, property, and rendering setting that are set for the material.

The name included in the material data is a name (e.g., soil, sand, grass, etc.) set for the material. It should be noted that during the game, the name of the material of the voxel object may be displayed. In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other examples, information different from those listed above may be set as information indicating a property of a material.

In the present example, the material data includes, as information that identifies a property of a material, an ID indicating the property (see FIG. 12). Although not shown in FIG. 12, the game system 1 stores, for each property to be prepared, property information in which the property ID is associated with the content of the property (e.g., a value indicating the aforementioned hardness or slipperiness). By referring to the property information, the game system 1 can specify the specific content of the property set for the material. It should be noted that in the present example, information indicating the presence or absence of an in-game effect described below or details thereof may be set as the information set as a property of a material or property information related to a property ID. In addition, information indicating the presence or absence of an in-game effect described below or details thereof may be specified in data other than the data shown in FIG. 12 and therefore included in the material data.

The rendering setting included in the material data is information that indicates setting regarding rendering, such as a texture used for rendering of the voxel object for which the material is set. In the present example, the material data includes, as information on rendering setting, an ID of a texture to be used for rendering the voxel object for which the material is set (see FIG. 12). Although not shown in FIG. 12, the game system 1 stores, for each texture prepared, texture information in which the texture ID is associated with the texture indicated by the texture ID. By referring to the texture information, the game system 1 can specify the specific content of the texture set for the material. In other examples, as information on rendering setting, any information regarding setting of shading may be set in addition to the texture information. For example, information regarding reflectivity, normal, or the like may be set.

The material data may include data other than the data shown in FIG. 12. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other examples, the material data may have a data structure including data that directly indicates the property and/or rendering setting of the material, instead of the data structure including the material ID and the texture ID.

### [2-2. Update of Voxel Data]

During the game, the voxel object is deformed when the voxel data is updated. In the present example, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 13 shows an example of a game space when an update event has occurred.

In the situation shown in FIG. 13, a player character 201 has performed a punching action to a terrain object 202 that is a voxel object. As will be described in detail below, in the example shown in FIG. 13, the voxel data is updated such that the terrain object 202 at and around a position hit by the punching action of the player character 201 is deleted. This represents how the terrain object 202 is destroyed by the punching action of the player character 201.

In the present example, when such an update event has occurred, the game system 1 sets, in the game space, an update range in which the voxel object is updated (in the example shown in FIG. 13, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 13, the position of the update range 203 may be determined based on a position that is hit by the punch of the player character 201. For example, the hit position, or a position a predetermined distance ahead of the hit position may be a center position of the update range 203. The shape and size of the update range may be determined in advance according to the type of the update event. For example, when an update event due to a punch of the player character 201 has occurred, the shape and size of the update range may be determined such that the update range is in the shape of a sphere having a predetermined size as shown in FIG. 13. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxels overlapping the update range. As a result of the change in the density, the mesh of the voxel object is changed by a process described below, thereby changing the shape of the voxel object (the shape by appearance, and the shape used for contact determination). In other examples, in addition to changing the density of the voxel included in the update range, the game system 1 may change the material in the voxel (e.g., the first material, the second material, and the material mixing ratio), or may change the state in the voxel.

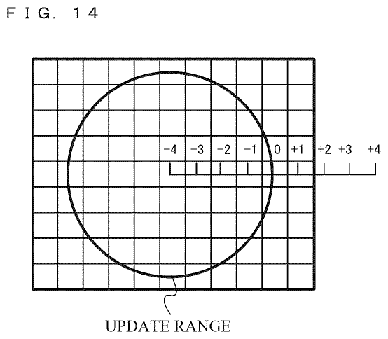

In the present example, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 14 shows an example of the update range. In the example shown in FIG. 14, a spherical update range is set in the game space. For example, in the example shown in FIG. 14, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

In the example described above, a change in which the voxel object within the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object. A change in which only the voxel material within the update range is changed while the voxel density is not changed, may be applied to the voxel object. A change in the voxel density and a change in the voxel material may be integrally applied.

### [2-3. Calculation of Vertices]

When the voxel density has been updated as described above, the game system 1 sets vertices based on the updated voxel data. The vertices can be vertices of a mesh of a voxel object. As will be described in detail below, in the present example, the vertices are simplified, and the simplified vertices become the vertices of the mesh of the voxel object.

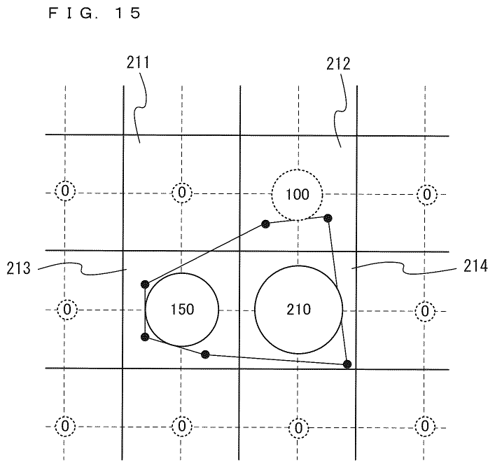

FIG. 15 shows an example of a method for setting vertices. In FIGS. 15 to 24, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the present example, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the present example, the density set for a voxel is in the range of 0 to 255. A voxel having a density of 0 is completely empty, and a voxel having a density of 255 is completely filled up. Densities between 0 and 255 are complementarily treated, and are used for determining a vertex. In the present example, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 15, a voxel 211 and the other outer voxels have a density of 0, a voxel 212 has a density of 100 which is less than the reference value (e.g., 128), and voxels 213, 214 respectively have densities of 150, 210 which are greater than the reference value. In the present example, the game system 1 generates vertices between the voxels whose densities are equal to or greater than the reference value and the voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 15, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 15.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the present example, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

### [2-4. Determination of Material of Vertex]

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). In other examples, the voxels used for determining the material of the vertex and the voxels used for determining generation of the vertex may not necessarily be the same, and may be different from each other.

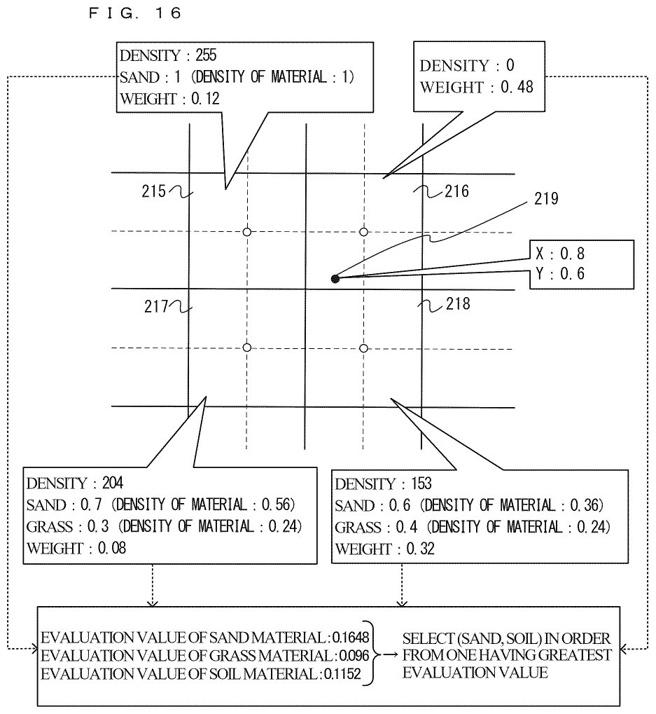

FIG. 16 shows an example of a method for determining a material of a vertex. In the example shown in FIG. 16, a vertex 219 is set with respect to four voxels 215 to 218, and the four voxels 215 to 218 correspond to the aforementioned “voxels around the vertex”. In an actual three-dimensional space, the number of voxels around the vertex is eight. In the example shown in FIG. 16, as for the voxel 215, a density of 255, a first material of “sand”, and a material mixing ratio of 0 (e.g., first material:second material=1:0, or the second material may not necessarily be set) are set. As for the voxel 216, a density of 0 is set (the first and second materials may not necessarily be set). As for the voxel 217, a density of 204, a first material of “sand”, a second material of “grass”, and a material mixing ratio of 0.3 (e.g., first material:second material=0.7:0.3) are set. As for the voxel 218, a density of 153, a first material of “soil”, a second material of “grass”, and a material mixing ratio of 0.4 (e.g., first material:second material=0.6:0.4) are set. In addition, the coordinates indicating the position of the vertex 219 are (X, Y)=(0.8, 0.6). A coordinate system for the coordinates has an X coordinate in the left-right direction and a Y coordinate in the up-down direction, in FIG. 16. In the coordinate system, among center positions of the voxels 215 to 218 (positions of white circles in FIG. 16), the center position of the lower-left voxel 217 is (0, 0).

In determining a material of the vertex, the game system 1 calculates an evaluation value for each of the materials of the neighboring voxels, based on the density of the material, and a weight value based on the distance from the voxel to the vertex. First, the weight value is calculated for each voxel. The shorter the distance from the center position of the voxel to the vertex is, the greater the weight value is. In the present example, assuming that the center position of a certain voxel is (x1, y1) and the coordinates of the vertex are (x2, y2), a weight value for the voxel is calculated according to the following formula (1).

$$( weight value ) = \vert ( 1 - x 1 ) - x 2 \vert \cdot \vert ( 1 - y 1 ) - y 2 \vert \qquad ( 1 )$$

In the example shown in FIG. 16, the weight values of the voxels 215 to 218 calculated according to the formula (1) are as follows.

$$( weight value of voxel 215 ) = \vert ( 1 - 0 ) - 0.8 \vert \cdot \vert ( 1 - 1 ) - 0.6 \vert = 0.12$$

$$( weight value of voxel 216 ) = \vert ( 1 - 1 ) - 0.8 \vert \cdot \vert ( 1 - 1 ) - 0.6 \vert = 0.48$$

$$( weight value of voxel 217 ) = \vert ( 1 - 0 ) - 0.8 \vert \cdot \vert ( 1 - 0 ) - 0.6 \vert = 0.08$$

$$( weight value of voxel 218 ) = \vert ( 1 - 1 ) - 0.8 \vert \cdot \vert ( 1 - 0 ) - 0.6 \vert = 0.32$$

The game system 1 calculates a density of a material for each voxel. Here, the density of the material is a value obtained by multiplying the proportion of this material, among materials set for the voxel, by the density of the voxel. In the present example, for the densities of the voxels, values obtained by normalizing the aforementioned values from 0 to 255 to values from 0 to 1 are used. In the example shown in FIG. 16, as for the voxel 215, since the material set for this voxel is only sand, the proportion regarding the sand material is 1, and the density of the voxel is 1, and therefore, the density of the sand material is 1. As for the voxel 216, since the density is 0 and no material is set, a material density is not calculated. If any material is set, the density of this material is 0. As for the voxel 217, the proportions of the sand material and the grass material being set are 0.7 and 0.3, respectively, and the density of the voxel is 204/255=0.8. Therefore, the density of the sand material is 0.7.0.8=0.56, and the density of the grass material is 0.3.0.8=0.24. As for the voxel 218, the proportions of the soil material and the grass material being set are 0.6 and 0.4, respectively, and the density of the voxel is 153/255=0.6. Therefore, the density of the soil material is 0.6.0.6=0.36, and the density of the grass material is 0.4.0.6=0.24.

Then, the game system 1 calculates the evaluation value for each material, based on the weight value and the density of the material. In the present example, the evaluation value of the material is a value obtained by weighting the density of the material calculated for each voxel, according to the weight value of the voxel, and summing up the weighted densities of the neighboring voxels. In the example shown in FIG. 16, the evaluation value of the sand material is 1.0.12+0.56.0.08=0.1648 because the density of the material is 1 and the weight value is 0.12 for the voxel 215, and the density of the material is 0.56 and the weight value is 0.08 for the voxel 217. The evaluation value of the grass material is 0.24.0.08+0.24.0.32=0.096 because the density of the material is 0.24 and the weight value is 0.08 for the voxel 217, and the density of the material is 0.24 and the weight value is 0.32 for the voxel 218. The evaluation value of the soil material is 0.36.0.32=0.1152 because the density of the material is 0.36 and the weight value is 0.32 for the voxel 218.

The game system 1 determines a material of the vertex, based on the evaluation values of the respective materials. Specifically, a predetermined number of materials in order from one having the greater evaluation value are determined as materials of the vertex. In the present example, two materials having the first and second greatest evaluation values are determined as materials of the vertex. In the example shown in FIG. 16, since the evaluation values of the sand, grass, and soil materials are 0.1648, 0.096, and 0.1152, respectively, the sand material and the soil material are determined as the materials of the vertex. Furthermore, the game system 1 calculates the ratio of the determined two materials, based on the evaluation values described above. In the present example, the ratio of the two materials may be represented as a second material ratio that is a ratio of the second material to the whole, like the aforementioned material mixing ratio. In the example shown in FIG. 16, for example, if the first material and the second material are set to soil and sand, respectively, the second material ratio is represented as 0.1648/(0.1648+0.1152)≈0.59. In other examples, as a value representing the ratio of the two materials, a value representing the proportion of the first material may be used. Alternatively, values representing the proportions of the respective materials may be used.

In the present example, the game system 1 generates and stores therein vertex data indicating the position of a vertex, material IDs of the first and second materials set for the vertex, and the ratio of the materials. However, the method for managing materials set for a vertex is discretionary. In other examples, the vertex data may have a data structure including data that directly indicates the contents of the first and second materials.

As described above, in the present example, regarding material IDs included in voxel data of a plurality of neighboring voxels around each vertex, the game system 1 calculates a priority parameter (e.g., evaluation value) for each material ID, based on the voxel data. Then, based on the priority parameters, the game system 1 selects a predetermined number of (here, two) material IDs having the higher priorities, and determines the selected material IDss as material IDs for the vertex. The specific parameter to be used as the priority parameter is not limited to the evaluation value. For example, in other examples, an evaluation value that is calculated using the density of the material without using the weight value may be used as a priority parameter.

In the present example, the evaluation value as an example of the priority parameter is calculated based on the densities of the plurality of neighboring voxels around the vertex such that the material set for the voxel having the higher density has the higher priority (e.g., the evaluation value of the material is increased and thereby the material is highly likely to be selected). Thus, the material of the vertex can be determined while also incorporating (e.g., reflecting) the magnitude of the density set for the voxel.

In the present example, the evaluation value as an example of the priority parameter is calculated based on the distances from reference positions (specifically, center positions) of a plurality of neighboring voxels around the vertex, to the vertex such that the material set for the voxel closer to the vertex has the higher priority. Thus, the material of the vertex can be determined while also incorporating (e.g., reflecting) the distances between the voxels and the vertex.

In the present example, it can also be said that the evaluation value as an example of the priority parameter is calculated based on the material mixing ratios of a plurality of neighboring voxels around the vertex such that the material having the higher material mixing ratio has the higher priority. Thus, in the case where a plurality of materials are set for one voxel, the material of the vertex can be determined while also incorporating (e.g., reflecting) the ratio of the materials.

### [2-5. Simplification of Vertices]

In the present example, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

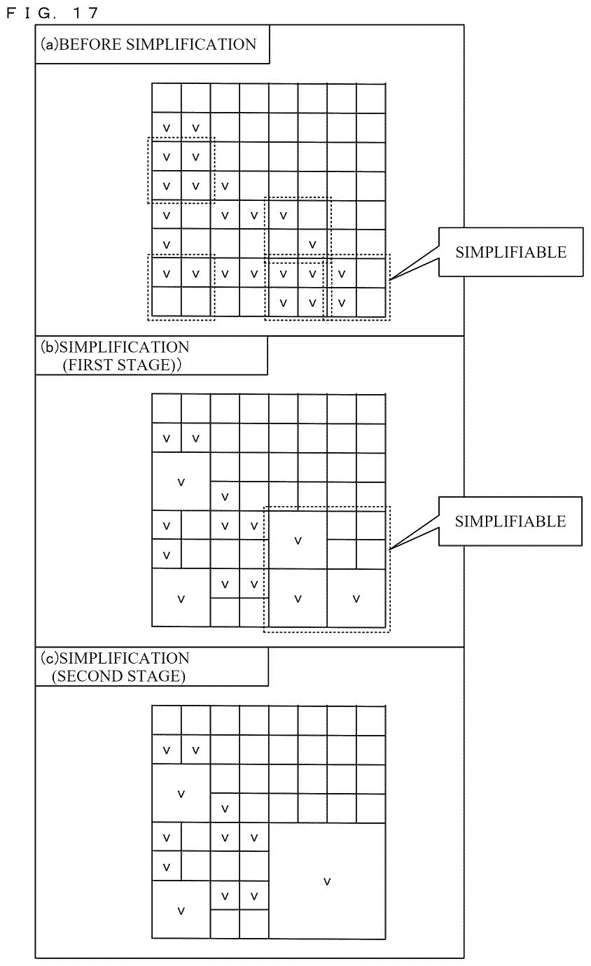

In the present example, the game system 1 performs simplification by representing vertices using SVO (Sparse Voxel Octree). FIG. 17 shows an example of vertex simplification. In FIG. 17, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 15 and FIG. 16. In FIG. 17, each vertex division region having a character “v” inside is a vertex division region in which a vertex is set.

In the present example, the game system 1 determines whether or not simplification can be performed with respect to the vertices in a predetermined number of (four in FIG. 17, and eight in an actual three-dimensional space) vertex division regions adjacent to each other. If the determination result is that simplification can be performed, simplification is performed for the vertices in the predetermined number of vertex division regions.

In FIG. 17, (a) shows the state before simplification is performed. In the example shown in FIG. 17, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) shown in FIG. 17). Thus, the vertices in the predetermined number of vertex division regions are simplified to one vertex.

In the present example, the game system 1 performs simplification in a plurality of stages. The number of the stages is discretionary. In FIG. 17, first and second stages are shown and described. In FIG. 17, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 17, when the determination result is that the vertex division regions within a range surrounded by dotted lines in (b) shown in FIG. 17 can be subjected to simplification, the vertices in the vertex division regions are simplified, resulting in the state shown in (c) of FIG. 17. The condition for determining whether or not the first-stage simplification can be performed and the condition for determining whether or not the second-stage simplification can be performed may be the same or different from each other.

The specific method for determining whether or not simplification can be performed is discretionary. In the present example, as conditions for the above determination, a condition regarding the shape of the voxel object and a condition regarding the material of the voxel object are used. In the present example, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

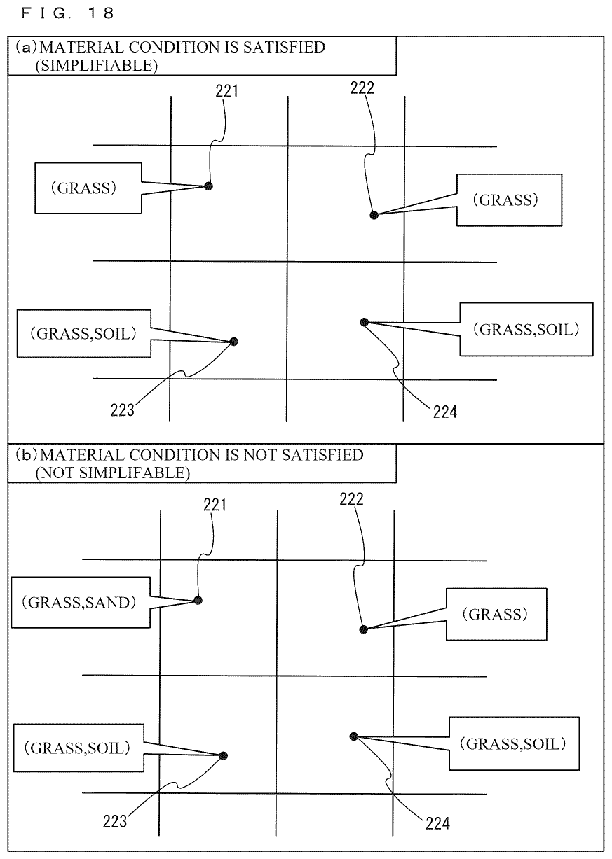

In the present example, as the condition regarding the material, a condition regarding the number of types of materials to be set for the vertices in the predetermined number of vertex division regions to be subjected to simplification, is used. FIG. 18 shows an example of the condition regarding the material. In FIG. 18, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the present example, the condition regarding the material is that the total number of the types of materials set for the vertices to be subjected to simplification is equal to or less than a predetermined number. For example, the condition regarding the material is that the total number is equal to or less than the number of materials that can be set for one vertex. In the present example, the predetermined number is 2. For example, in the case of (a) shown in FIG. 18, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object is satisfied. On the other hand, in the case of (b) shown in FIG. 18, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the condition regarding the shape of the object is satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the present example, at most two types of materials can be set for a vertex as in the case of a voxel. Meanwhile, in the present example, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the present example, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification. In the present example, the radio of the materials after the simplification is calculated similarly to the aforementioned method for calculating the ratio of materials of vertices by using the evaluation values. That is, the game system 1 calculates weight values based on the distances between the vertex after the simplification and the vertices before the simplification, and calculates an evaluation value for each material, based on the weight values and the densities of the materials of the vertices before the simplification (the evaluation values of the materials described in the above [2-4. Determination of material of vertex] can be used as the densities of the materials here). Then, the ratio of the materials is calculated based on the calculated evaluation values of the materials.

### [2-6. Generation of Mesh]

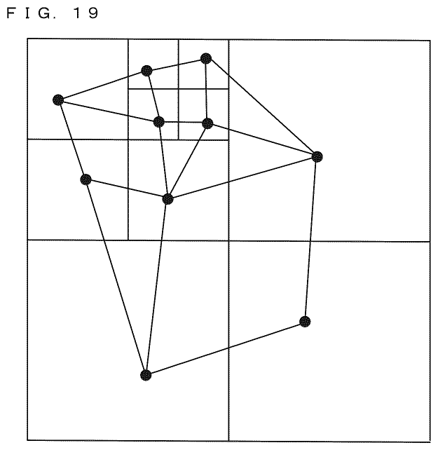

In the present example, a mesh of a voxel object is generated based on vertices having been simplified as described above. FIG. 19 shows an example of a mesh generated based on such vertices. Each of squares shown in FIG. 19 represents a vertex division region as described above, or a vertex division region obtained by integrating a plurality of vertex division regions through simplification. As shown in FIG. 19, the game system 1 generates a mesh that is composed of polygonal shapes each having, as one side, a straight line connecting vertices of adjacent vertex division regions. Each of the polygonal shapes forming the mesh is a triangle or a quadrangle.

In the present example, the game system 1 generates two types of meshes—e.g., a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the present example, the game system 1 generates the display mesh and the determination mesh, based on data of the SVO described above (e.g., based on the simplified vertices). Thus, sharing vertex data in generating the two types of meshes improves efficiency of processing. In other examples, the game system 1 may not necessarily perform simplification of vertices, and may generate a display mesh and/or a determination mesh, based on vertices that are not simplified.

In the present example, the game system 1 generates the determination mesh so as to be simpler in shape than the display mesh. Specifically, the game system 1 makes the number of vertices of the determination mesh less than the number of vertices of the display mesh. Here, in the present example, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other examples, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

### [2-6-1. Determination of Material of Display Mesh]

Next, an example of a method for determining materials and an appearance of a display mesh will be described. In the present example, the game system 1 determines a material for each of the polygonal shapes forming the display mesh. As will be described in detail below, in the present example, a polygon corresponding to each polygonal shape is rendered using at most two types of textures corresponding to at most two types of materials. Therefore, the game system 1 determines materials for the polygonal shapes forming the mesh such that two or less types of materials are finally set for one polygonal shape. In other examples, three or more materials may be set. For example, in an example in which three or more types of voxel materials and three or more types of vertex materials are set, the same number of materials may be set for the polygonal shapes.

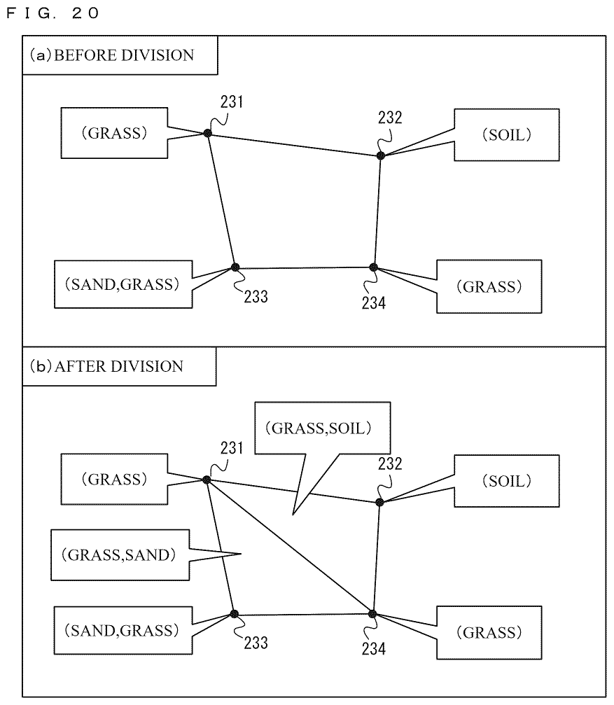

In the present example, quadrangles may be formed as polygonal shapes forming the display mesh (see FIG. 19). In determining materials of the display mesh, the game system 1 firstly divides each of the quadrangles forming the display mesh into two triangles under certain conditions. Hereinafter, a process of dividing a quadrangle into two triangles will be described with reference to FIG. 20.

FIG. 20 shows an example of dividing a quadrangle forming a mesh into two triangles. In FIG. 20, (a) shows a quadrangle before division, formed by vertices 231 to 234 included in the vertices of the mesh. In FIG. 20, (b) shows two triangles into which the quadrangle is divided. In the example shown in FIG. 20, “grass”, “soil”, “sand and grass”, and “grass” are set as materials of the respective vertices 231 to 234.

In the present example, if the number of types of materials set for the vertices of the quadrangle is three or more in total, the game system 1 determines whether or not a division condition is satisfied. In the present example, the division condition is that dividing the quadrangle into two triangles allows the number of types of materials set for the vertices of each triangle to be two or less in total. If the division condition is satisfied, the game system 1 divides the quadrangle into two triangles each having two or less types of materials set for the vertices. In the example shown in FIG. 20, three types of example materials, grass, soil, and sand, are set for the vertices 231 to 234 forming the quadrangle. If the quadrangle is divided into a triangle formed by the vertices 231, 232, 234 and a triangle formed by the vertices 231, 233, 234, two types of materials, sand and grass, are set for the vertices of the former triangle, and two types of materials, grass and soil, are set for the vertices of the latter triangle (see (b) shown in FIG. 20). Since the division condition is satisfied for the quadrangle, the game system 1 divides the quadrangle into two triangles.

Since there are two methods for dividing a quadrangle into two triangles, if the division condition is satisfied for the triangles into which the quadrangle is divided by at least one of the two methods, the game system 1 performs the division by the method satisfying the division condition. Meanwhile, if the division condition is not satisfied for the triangles into which the quadrangle is divided by either of the two methods, the game system 1 performs the division by either method.

By performing the division as described above, the game system 1 can generate two triangles each having two or less types of materials set for the vertices, without missing information on three or more types of materials set for the vertices of the quadrangle as much as possible. Here, as described above, each of the polygons forming the mesh is rendered using at most two types of textures. Therefore, by performing the division, the game system 1 can render each polygon by using two types of textures without missing information on the materials set for the vertices as much as possible.

In the present example, the game system 1 sets polygons corresponding to the polygonal shapes obtained through the aforementioned division. That is, the vertices of the polygonal shapes obtained through the division become the vertices of the polygons of the display mesh.

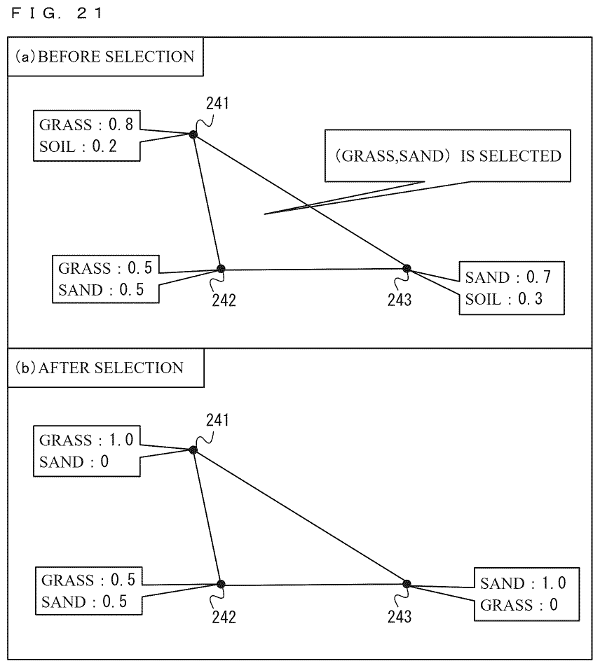

In the present example, as for the polygons forming the display mesh, if the number of types of materials set for the vertices of one polygon is three or more in total, the game system 1 selects two types of materials to determine materials of this polygon. FIG. 21 shows an example of a method for determining materials of a polygon forming the display mesh. In the example shown in FIG. 21, as for a vertex 241 of a triangular polygon forming the display mesh, the first material is “grass”, the second material is “soil”, and the material ratio of the first material to the second material is 0.8:0.2. As for a vertex 242 of the polygon, the first material is “grass”, the second material is “sand”, and the material ratio of the first material to the second material is 0.5:0.5. As for a vertex 243 of the polygon, the first material is “sand”, the second material is “soil”, and the material ratio of the first material to the second material is 0.7:0.3.

If the number of types of materials set for the vertices of the polygon is three or more in total, the game system 1 calculates a determination value for each material. The determination value is calculated as a sum of the proportions of the material at the vertices on which the material is set. Then, the game system 1 selects two materials in order from one having the greatest determination value, as materials of the polygon. In the example shown in FIG. 21, the determination value of the grass material is 0.8+0.5=1.3, the determination value of the sand material is 0.5+0.7=1.2, and the determination value of the soil material is 0.2+0.3=0.5. Therefore, the grass material and the sand material are selected as materials of the polygon shown in FIG. 21 (see (a) shown in FIG. 21).

The specific method for selecting a material of a polygon of the display mesh is discretionary. In other examples, a material of a polygon of the display mesh may be selected by any method based on information set for the vertices of the polygon. For example, a material of a polygon of the display mesh may be selected as follows. That is, a material having the greatest proportion at one vertex is specified for each vertex, and a material that is most frequently specified for each vertex is selected as a material of the polygon.

In the present example, the selected materials of the polygon are indicated as materials set for the vertices of the polygon. That is, when the materials of the polygon have been selected, the game system 1 changes the materials being set for the vertices of the polygon (e.g., the material IDs included in the vertex data) to the selected materials. In the example shown in FIG. 21, as for the vertex 241 and the vertex 243, “grass and soil” and “sand and soil” are respectively set before the selection of materials of the polygon (see (a) shown in FIG. 21). When grass and sand have been selected as materials of the polygon as described above, the materials set for the vertex 241 and the vertex 243 are changed to “grass and sand” (see (b) shown in FIG. 21). Since the materials set for the vertex 242 before the selection are the same as the selected materials of the polygon, the materials are not changed. In the case where two types of materials are selected as materials of the polygon as described above, information on the third and subsequent types of materials set for the vertices of the polygon are deleted.

According to the change of the materials set for each vertex, the game system 1 changes the ratio of the materials set for the vertex. For example, as for the vertex 241, the content indicating that the first material is grass and the second material is soil is changed to the content indicating that the first material is grass and the second material is sand. Here, since the proportion of the sand material is 0, the material ratio of the first material to the second material becomes 1:0. Thus, the above change is formally changing the materials of the vertices of the polygon in order to represent the materials of the polygon by the materials of the vertices of the polygon.

According to the above, since the materials set for the vertices of one polygon are only the materials corresponding to the textures used for rendering described below, a rendering process using the textures can be easily performed.

There may be a case where the aforementioned change causes all the materials at a certain vertex to be changed (e.g., none of the materials after the change correspond to the materials before the change). For example, there is a case where the material set for the vertex before the change is soil, and the materials selected as materials of the polygon are grass and sand. In this case, the ratio of the materials at the certain vertex may be set based on the material ratios at the other vertices of the polygon. For example, in the above example, in the case where the first material set for one of the remaining two vertices of a triangular polygon is grass and the material ratio of grass to sand is 1:0 while the material set for the other vertex is sand and the material ratio of sand to grass is 1:0, the material ratio at the certain vertex may be set to grass:sand=0.5:0.5. The game system 1 may determine the material ratio at the certain vertex in consideration of the distance between this vertex and the other vertex (e.g., based on a weight value that increases as the distance is shorter).

As described above, in the present example, the game system 1 selects, for each polygon, at most a predetermined number of (here, two) material IDs from among the material IDs set for the vertices included in the polygon (e.g., material IDs set for the vertices of the polygonal shape corresponding to the polygon), and determines the selected material IDs as material IDs of the polygon. Thus, the game system 1 can perform the rendering process with the number of textures to be used being reduced, while incorporating (e.g., reflecting) the materials set for the vertices into the appearance of the polygon.

In the present example, regarding the materials of all the vertices forming a polygon, if the number of the materials is equal to or less than the predetermined number, the game system 1 determines the materials as materials of the polygon. Meanwhile, if the number of the materials exceeds the predetermined number, the game system 1 selects a predetermined number of materials having higher priorities, based on the priority parameters of the vertices (specifically, based on the determination values calculated based on the aforementioned evaluation values), and determines the selected materials as materials of the polygon. Thus, even if the number of the materials set for the vertices exceeds, in total, the predetermined number, the number of the materials of the polygon can be made equal to or less than the predetermined number in consideration of the priority.

As described above, in the present example, the first and second materials set for each of the vertices of one polygon are changed to the two types of materials to be set for the polygon. In performing such a change, as for a vertex shared by adjacent two polygons, there is a possibility of inconsistency in the first and second materials to be set.

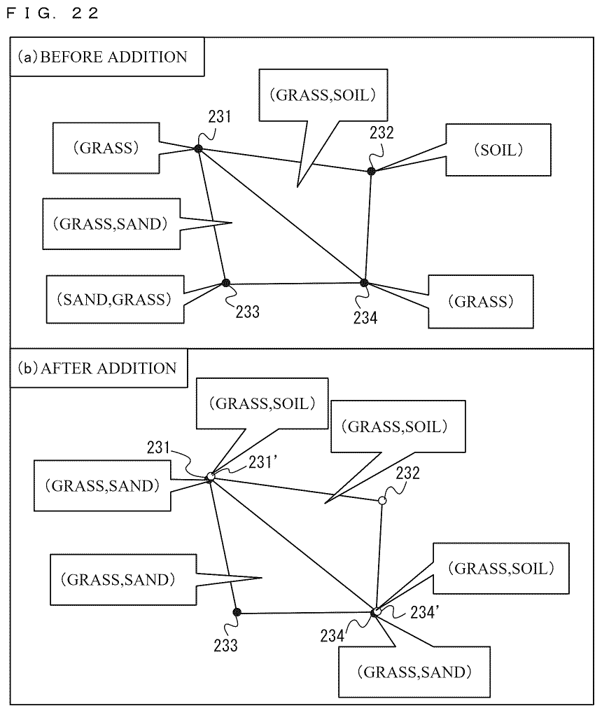

FIG. 22 shows an example of materials set for vertices of adjacent two polygons. FIG. 22 shows a state in which two polygons are formed by the vertices 231 to 234 shown in FIG. 20 ((b) shown in FIG. 20). In the example shown in FIG. 22, since grass and sand are determined as materials of a first polygon formed by the vertices 231, 233, and 234, the first and second materials of these vertices should be set to grass and sand, respectively. Meanwhile, since grass and soil are determined as materials of a second polygon formed by the vertices 231, 232, and 234, the first and second materials of these vertices should be set to grass and soil, respectively. Therefore, in the example shown in FIG. 22, as for the vertices 231 and 234 shared by the two polygons, inconsistency occurs in the materials to be set.

In the present example, when inconsistency occurs in material to be set for a vertex shared by two polygons, the game system 1 adds another vertex at the position of the vertex. In FIG. 22, (b) shows an example of a state in which a vertex 231′ is added for the vertex 231 and a vertex 234′ is added for the vertex 234. In the example shown in FIG. 22, the game system 1 sets, for the vertices 231 and 234, grass and sand as the first and second materials according to the materials of the first polygon. In addition, the game system 1 sets, for the vertices 231′ and 234′, grass and soil as the first and second materials according to the materials of the second polygon. By formally setting two vertices as vertices to be shared by two polygons (e.g., by generating data of two vertices located at the same position and having different materials), it is possible to inhibit occurrence of inconsistency in materials to be set for the vertices.

The game system 1 generates a display mesh composed of the polygons whose vertices and materials are determined as described above. In addition, the game system 1 renders the polygons, based on information on the materials set for the vertices (e.g., the first material and the second material), thereby rendering a voxel object.

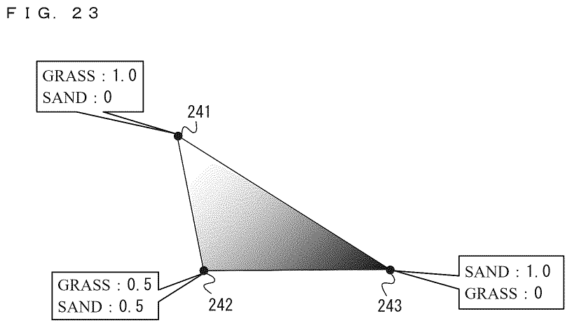

FIG. 23 shows an example of applying a texture to a polygon. FIG. 23 shows a triangular polygon formed by the vertices 241 to 243 shown in FIG. 21. The materials set for the vertices 241 to 243 are those shown in (b) shown in FIG. 21.

As for the position of a vertex of a polygon, rendering is performed by a mapping in which a texture of a first material set for the vertex and a texture of a second material set for the vertex are blended at a ratio of the materials set for the vertex (e.g., using this ratio as a blending ratio). The textures of the first and second materials used for the rendering are textures indicated by information on rendering setting associated with the material ID that is associated with data of the vertex in the aforementioned material data (see FIG. 12). In the example shown in FIG. 23, as for the position of the vertex 241, since the material ratio of grass to sand is 1:0, rendering is performed by using only the texture of grass. As for the position of the vertex 243, since the first material is sand and the material ratio of sand to grass is 1:0, rendering is performed by using only the texture of sand. As for the position of the vertex 242, since the first material is grass, the second material is sand, and the material ratio of grass to sand is 0.5:0.5, rendering is performed such that the texture of grass and the texture of sand are blended at a blending ratio of 0.5:0.5.

As for positions other than the vertices of the polygon, the game system 1 determines a blending ratio by interpolating the blending ratios at the vertices. Then, rendering is performed by a mapping in which the textures of two materials set for each vertex are blended at the interpolated blending ratio. The specific method for interpolation is discretionary. As an example, a blending ratio between vertices is subjected to linear interpolation. In FIG. 23, a position at which the texture of grass material is applied at a high ratio is shown in white, and a position at which the texture of sand material is applied at a high ratio is shown in black. In the example shown in FIG. 23, the texture of grass is applied to the vertex 241, and the blending ratio of the texture of sand increases toward the vertex 243. At the position of the vertex 242, the blending ratio of grass to sand becomes 1:1, and only the texture of sand is applied at the position of the vertex 243. Thus, rendering is performed with the two textures set for the polygon (e.g., set for the vertices of the polygon) being blended with the blending ratio according to the material ratio, whereby the appearance at the boundary between different materials can be made natural in the display mesh. This makes the appearance of the display mesh, in which a plurality of types of materials are set, natural.

### [2-6-2. Determination of Material of Determination Mesh]

Next, an example of a method for determining materials of a determination mesh will be described. As will be described in detail below, in the present example, there may be a case where collision determination is performed for a voxel object by using a determination mesh, and processing is performed according to a material of a voxel object for which a collision has been determined. Therefore, in the present example, materials are determined also for the determination mesh.

In the present example, the game system 1 sets polygons corresponding to the polygonal shapes forming the determination mesh such that one type of material is set for one polygon. Specifically, the game system 1 determines a material to be set for a polygon of the determination mesh, based on information on materials set for vertices of this polygon (e.g., information on first and second materials, and a material ratio).

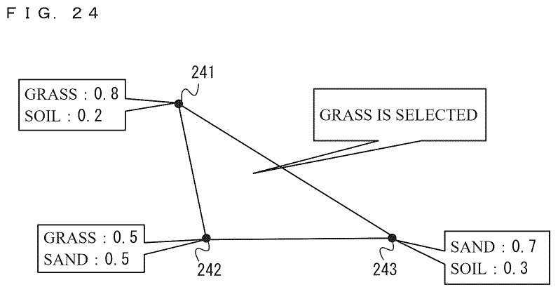

FIG. 24 shows an example of a method for determining a material of a polygon forming the determination mesh. FIG. 24 shows an example of determining a material for a triangular polygon formed by the vertices 241 to 243 shown in FIG. 21. The materials set for the vertices 241 to 243 are those shown in (a) shown in FIG. 21.

In determining a material of a polygon, the game system 1 calculates a determination value for each of materials set for the vertices of the polygon. In the present example, a calculation method for the determination value is identical to the calculation method for the determination value that is used for selection of the materials to be set for the polygonal shapes of the display mesh. The specific calculation method for the determination value is discretionary. In other examples, the determination value may be calculated in any method based on information set for the vertices of the polygon of the determination mesh.

In the example shown in FIG. 24, the determination value for each material is 1.3 for the grass material, 1.2 for the sand material, and 0.5 for the soil material as in the case shown in FIG. 21. Therefore, the grass material is selected as a material of the polygon shown in FIG. 24.

As described above, in the present example, the game system 1 selects, for each polygon, at most a predetermined number of (here, one) material IDs from among the material IDs set for the vertices included in the polygon (e.g., material IDs set for the vertices of the polygonal shape corresponding to the polygon), and determines the selected material ID as a material ID of the polygon. This allows the game system 1 to reduce the number of materials to be set for the determination mesh to the predetermined number or less. Thus, processing based on the material type, which is performed according to the result of collision determination using the determination mesh, is prevented from being complicated. The method for determining a material of a polygon of the determination mesh is discretionary, and is not limited to the above method. In other examples, a material of a polygon of the determination mesh may be determined by any method based on information set for the vertices of the polygon.

In the present example, one type of material is set for a polygon of the determination mesh while at most two types of materials are set for a polygon of the display mesh. Therefore, natural appearance can be achieved for the polygon of the display mesh by using two types of textures. In addition, as for the determination mesh, a process to be performed according to the result of collision determination using the determination mesh can be prevented from being complicated. In other examples, the types of materials settable for polygons of the display mesh and the determination mesh are discretionary. The number of materials settable for a polygon of the display mesh and the number of materials settable for a polygon of the determination mesh each may be plural, and may be the same or different from each other.

In the present example, the number of types of materials to be set for one voxel is two at most, and the number of types of materials to be set for one polygon in the display mesh is two at most. Thus, information on materials set in the voxel data can be used for (e.g., reflected in) the materials of the display mesh while reducing the data amount of the voxel data. Moreover, in the present example, the number of types of materials to be set for vertices based on the voxel data is also two at most (see FIG. 16). In this case, since two types of materials can be set also for vertices that are generated during the process to obtain the display mesh from the voxel data, the information on materials set in the voxel data used for (e.g., reflected in) the display mesh, without missing the information on materials during the process.

In other examples, the game system 1 may set materials such that, regarding vertices to be set based on the voxel data, materials set for vertices to be used for generation of the display mesh are different from materials set for vertices to be used for generation of the determination mesh. For example, the game system 1 may set at most two types of materials as described above for the vertices to be used for generation of the display mesh, and may set one type of material for the vertices to be used for generation of the determination mesh. Then, the game system 1 may set two types of materials as materials of a polygon of the display mesh, and may set one type of material as a material of a polygon of the determination mesh, based on one type of material that is set for each vertex of this polygon. In setting one type of material for the vertices to be used for generation of the determination mesh, a material having the greatest determination value, among the determination values calculated for each material, may be set as materials of the vertices. Also in this case, as in the present example, the number of types of materials to be set for one polygon in the display mesh may be two at most, and the number of types of materials to be set for one polygon in the determination mesh may be one. Therefore, the information on materials set in the voxel data can be used for (e.g., reflected in) the display mesh, and the process to be performed according to the result of collision determination using the determination mesh is prevented from being complicated.

As described above, in the present example, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated within a range where collision determination is performed, and may not necessarily be generated within a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

In addition, in another example, only one of the display mesh and the determination mesh may be set (e.g., the display mesh and the determination mesh are the same mesh). In that case, the display mesh may also be used as the determination mesh, or the determination mesh may also be used as the display mesh. Thus, the same mesh may be shared as the display mesh and the determination mesh. In the case in which different meshes are used as the determination mesh and the display mesh, meshes suitable for respective applications can be used. In the case in which the same mesh is shared between rendering and collision determination, the processing load for setting a mesh can be reduced.

[2-7. Process of Producing in-Game Effect by Consumption of Voxel Object]

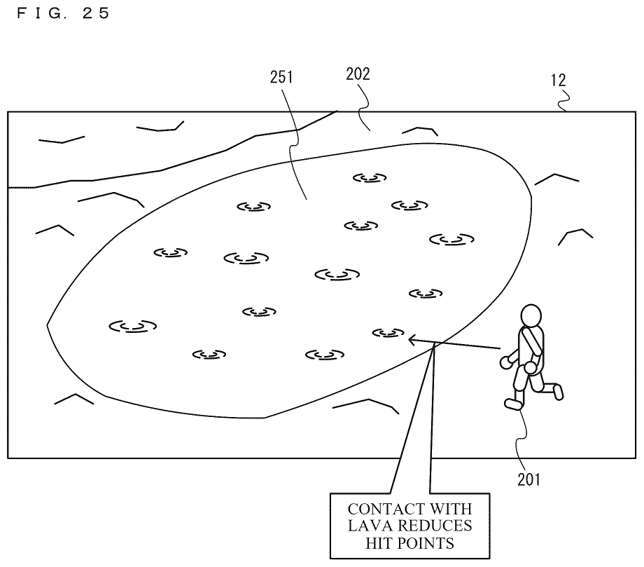

Next, an example of a process of producing an in-game effect by consumption of a voxel object, depending on a material, will be described with reference to FIGS. 25 to 38. In the following description, it is assumed that terrain objects such as grounds and walls are a voxel object. In the present example, when a player character performs an action, an in-game behavior occurs as a result of collision determination for a voxel object. In addition, in the present example, in the case in which a material of a voxel object is a particular material, an in-game effect corresponding to the particular material is produced for the voxel object. In the following description, an example in which the in-game behavior and the in-game effect occur will be described.

The “in-game behavior” can include any change that occurs in the game. The in-game behavior is, for example, a change that occurs due to a “process of reflecting a result of contact between objects”. The “in-game behavior” may be any behavior as long as it is based on collision determination between the determination mesh and a determination shape corresponding to a determination target based on the game processing (e.g., a determination region set for an object such as the player character). The behavior may also occur in an object corresponding to the determination mesh. The content of the “in-game behavior” may be associated with a material set for a polygon on which a collision has been determined in collision determination that causes occurrence of the behavior (e.g., the content of the behavior may be determined based on the material).

In addition, the “in-game effect” is any effect that is obtained when the size of a voxel object is reduced according to game progression. For example, in the case in which a material of a voxel object is a particular material, an in-game effect corresponding to the particular material is produced for the voxel object. For example, the voxel object is a fragment object that is generated when the voxel object is pulled out of the terrain object by a player character's action, and an in-game effect associated with a material of the fragment object is produced. When the size of the fragment object is smaller than a predetermined reference due to the in-game effect, the in-game effect is ended.

FIG. 25 shows an example of a game image representing a state in which a player character moves on a terrain object. In the example shown in FIG. 25, materials of polygons in a region 251 that is a portion of a determination mesh of the terrain object that is a ground are set to “lava”. Meanwhile, materials of polygons in a region 252 excluding the region 251 in the determination mesh of the terrain object are set to “rock”. For the voxels corresponding to the region 251, the first material ID is set to “lava” and the material mixing ratio is set to zero (e.g., only one kind of material that is “lava” is set for the voxels).

In the example shown in FIG. 25, the game system 1 performs collision determination between the terrain object and the player character 201 by using the determination mesh. That is, the game system 1 performs collision determination as to whether or not the determination mesh of the terrain object comes into contact with a determination region set for the player character (e.g., a region having a predetermined shape that is set based on the position of the player character). When a collision between the polygon whose material is lava and the player character 201 has been determined, a process of reducing the hit points of the player character 201 are executed as a process of generating an in-game behavior. Moreover, in the above case, a process of causing the player character 201 to perform a predetermined reaction is executed.

In the present example, regarding the lava material, a property of reducing the hit points of the player character that has come into contact with the material (e.g., a property of having a temperature equal to or higher than a predetermined value) is set as property information included in the aforementioned material data. The game system 1 generates an in-game behavior (in the above example, reduction in the hit points of the player character) based on the property information corresponding to the material set for the polygon in the determination mesh for which a collision has been determined through the collision determination.

When a collision between a polygon whose material is rock and the player character 201 has been determined, the process of reducing the hit points of the player character is not executed. Based on the collision, the player character 201 is controlled so as not to be able to enter the polygon. Therefore, the player character can stand and walk on the polygon. Thus, in the present example, by setting a material for each polygon, the game system 1 can execute different processes depending on which part of the voxel object another object has come into contact with. In addition, the content of a process to be executed can be matched to the type of the material.

The content of the process to be performed when a collision between the voxel object and another object has been determined, is discretionary. For example, if the other object is a moving object such as the player character or an enemy character, the process may be a process of outputting the sound of footsteps of the object, or displaying an effect (e.g., effect of representing dust or splash of water) on the contact part. In this case, the game system 1 can change the sound of footsteps or the effect according to the type of the material set for the polygon, in the contact part, of the voxel object.

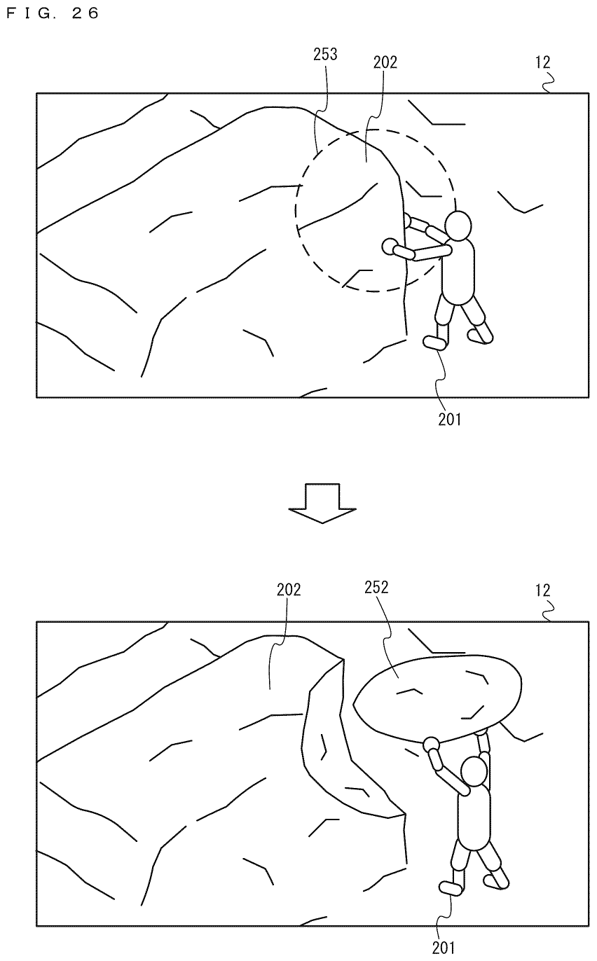

FIG. 26 is a diagram showing an example of a game image representing a state in which a player character 201 pulls a fragment object 252 out of a terrain object 202. As shown in FIG. 26, in the present example, the user, through a predetermined operation input, can cause the player character 201 to perform an action of holding the terrain object 202, pulling out a portion of the terrain object 202 as the fragment object 252, and grasping the fragment object 252 (hereinafter referred to as “pull-out action”). The game system 1 deletes the portion of the terrain object 202 and generates the fragment object 252 as an in-game behavior caused by the pull-out action.

For example, in performing the pull-out action, the game system 1 executes the following process. For example, when an operation input that causes the player character to perform the pull-out action has been performed by the user, the game system 1 causes the player character 201 to perform an action of digging forward and holding, and performs collision determination. Then, when a collision between the player character 201, which has performed the pull-out action, and the terrain object has been determined, the game system 1 generates an update range 253 based on the position and direction of the player character 201. For example, the update range 253 is generated in a predetermined direction (e.g., forward) with reference to the player character 201. The shape and size of the update range 253 may be determined in advance according to the type or level of the action of the player character 201. Furthermore, the game system 1 decreases the densities of voxels corresponding to the update range 253. Then, update of the mesh according to the decrease in densities of the voxels causes the terrain object 202 to be deformed such that the part inside the update range 253 is deleted (see the lower diagram of FIG. 26). In the present example, the densities of the voxels corresponding to the update range 253 are decreased. However, voxels whose densities are to be decreased may be at least part of the voxels corresponding to the update range 253.

In the present example, the voxel object corresponding to the update range 253 is unconditionally deformed due to the pull-out action. In other examples, the voxel object corresponding to the update range 253 may be deformed on the condition of the amount of damage set for the voxels. For example, instead of unconditionally deforming the voxel object corresponding to the update range 253, the game system 1 may increase the amount of damage set for the voxels corresponding to the update range 253, and decrease the densities of the voxels in response to the amount of damage having exceeded a predetermined value. In this case, the amount of increase in the damage may be determined according to the action performed to the voxel object.

The game system 1 generates the fragment object 252 representing the deleted part of the terrain object 202. For example, as shown in the lower diagram of FIG. 26, based on the pull-out action, the game system 1 generates the fragment object 252 in the state of being held by the player character. The fragment object 252 may be generated so as to have a shape corresponding to the deleted part of the terrain object 202, or a predetermined shape. A specific voxel space different from the voxel space of the voxels corresponding to the terrain object 202 or the like is defined for the fragment object 252.

The game system 1 determines a material of the fragment object 252. The material of the fragment object 252 is determined based on materials set for polygons in a determination mesh that comes into contact with the update range 253 among determination meshes of the terrain object 202. The material of the fragment object 252 is determined to be the same as at least one of the materials set for the polygons in the determination mesh that comes into contact with the update range 253. Thus, the material of the fragment object 252 can be made identical to the material of the deleted part of the terrain object 202. As is apparent from the above description, the fragment object 252 is actually not a part of the terrain object 202. However, since the fragment object 252 is generated simultaneously with deletion of a part of the terrain object and takes over the material of the deleted part of the terrain object 202, an impression that the player character 201 removes a part of the terrain object 202 by a pull-out action can be given to the user. It should be noted that as another example, the material of the fragment object 252 may be determined based on a material set in the voxel data for voxels that are in contact with the update range 253.

In the present example, priorities are set for the types of materials prepared, and the game system 1 determines, as a material of the fragment object 252, a material having the highest priority among the materials set for the polygons of the determination mesh in the update range 253. If the determination mesh in the update range 253 includes polygons for which different types of materials are set, it may be difficult for the user to predict a material of the fragment object 252, and the above inconvenience may occur against the user's will. Meanwhile, in the present example, since the priorities are given to the materials to be set as a material of the fragment object 252, the risk of the above inconvenience can be reduced. It should be noted that in another example, the game system 1 may determine, as a material of the fragment object 252, a material having the highest material mixing ratio of the materials set for the polygons of the determination mesh in the update range 253. Furthermore, not only the priority levels, but also a setting for excluding a particular material from those to be pulled out, may be set. For example, in the case in which the determination mesh in the update range 253 includes polygons whose material is rock and polygons whose material is lava, then if a material of the fragment object 252 is set to lava, the hit points of the player character 201 are reduced when the player character 201 grasps the fragment object 252 by performing the pull-out action (it should be noted that as described with reference to FIG. 25, it is assumed that the lava material has the property that the hit points of the player character 201 are reduced when the player character 201 comes into contact with the lava material), which is likely to be an inconvenience. Therefore, materials that cause damage such as lava may be excluded from those to be pulled out, and therefore, may not be included in materials of the fragment object 252.

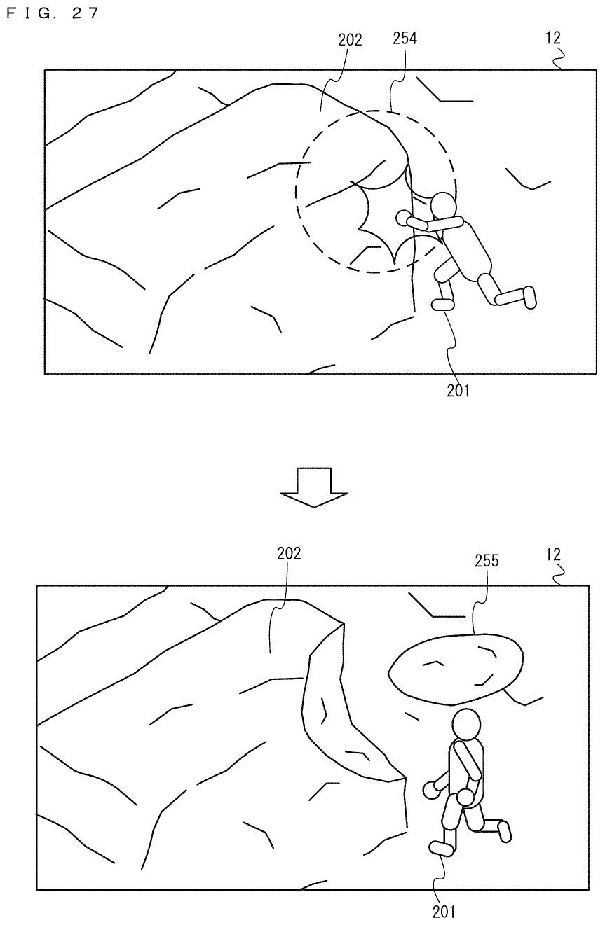

FIG. 27 shows an example of a game image representing a state in which a fragment object is generated by the player character 201 destroying the terrain object 202. As shown in FIG. 27, in the present example, the user, through a predetermined operation input, can cause the player character 201 to perform a punching action. As in the case of the aforementioned pull-out action, the game system 1 deletes a part of the terrain object 202 and generates a fragment object 254, as an in-game behavior caused by the punching action. Specifically, the game system 1 deforms the terrain object 202 such that a part of the terrain object 202 is deleted. In the case of the punching action, unlike the aforementioned pull-out action, the fragment object 254 is not held by the player character 201 but is disposed near the position where the punching action has been performed (see the lower diagram of FIG. 27).

In performing the punching action, specifically, the game system 1 executes the following process. For example, when an operation input to cause the player character 201 to perform the punching action has been performed by the user, the game system 1 causes the player character 201 to perform an action of punching forward, and performs collision determination. Then, when a collision between the player character 201, which has performed the punching action, and the terrain object 202 has been determined, the game system 1 generates an update range 255 based on the position and direction of the player character. For example, the update range 255 is generated in a predetermined direction (e.g., forward) with reference to the player character 201. The position, shape, and size of the update range 255 due to the punching action may be the same as or different from those of the update range 253 due to the pull-out action. Then, the game system 1 decreases the densities of voxels corresponding to the update range 255. Thus, the terrain object 202 is deformed such that the part inside the update range 255 is deleted by the punching action, similarly to the pull-out action (see the lower diagram of FIG. 27). In the case of the punching action, as in the case of the pull-out action, instead of unconditionally deforming the voxel object corresponding to the update range 255, the game system 1 may increase the amount of damage set for the voxels in the update range 255 according to the punching action, and decrease the densities of the voxels in response to the amount of damage having exceeded a predetermined value. In addition, the voxels whose densities are to be decreased by the punching action may be at least part of the voxels corresponding to the update range 255.

The game system 1 generates a fragment object 254 corresponding to the deleted part of the terrain object 202. That is, based on the punching action, the game system 1 generates the fragment object 254 in the state of not being held by the player character 201 (e.g., in the state of being disposed near the position where the punching action has been performed). The fragment object 254 may be a voxel object, and may be generated so as to have a shape corresponding to the deleted part of the terrain object 202, or a predetermined shape.

The game system 1 determines a material of the fragment object 254. The material of the fragment object 254 is determined based on materials set for polygons in a determination mesh that comes into contact with the update range 255 among the determination meshes in the terrain object 202. The material of the fragment object 254 is determined to be the same as at least one of the materials set for the polygons in the determination mesh that comes into contact with the update range 255. Thus, the material of the fragment object 254 can be made identical to the material of the deleted part of the terrain object 202. Since the fragment object 254 is generated simultaneously with deletion of a part of the terrain object 202 and takes over the material of the deleted part of the terrain object 202, an impression that a part of the terrain object 202 destroyed due to a punching action of the player character 201 is generated as the fragment object 254 can be given to the user.

In the present example, the material of the fragment object 254 is set to a material having the greatest degree of decrease in voxel density among the materials set for the polygons in the determination mesh that comes into contact with the update range 255. This allows generation of the fragment object 254 in which the material composition of the part, of the terrain object 202, deleted due to the punching action is more accurately shown (e.g., reflected).

The method for determining the material of the fragment object 252 or 254 removed by the pull-out action or the punching action is discretionary. For example, the method for determining the material of the fragment object 252 or 254 may be the same between the pull-out action and the punching action. Moreover, for example, among the materials set for the polygons of the determination mesh in the update range 253 or 255, a material that is set for the largest number of polygons may be determined as the material of the fragment object 252 or 254. Alternatively, for example, a material that is set for a polygon satisfying a predetermined condition (e.g., a polygon at a position that comes into contact with a hand of the player character 201, which is performing the pull-out action or the punching action) among the polygons of the determination mesh in the update range 253 or 255, may be determined as the material of the fragment object 252 or 254. In other examples, a plurality of types of materials may be set for the fragment object 252 or 254.

In the present example, the user can perform various actions using a fragment object that is generated by being removed from a terrain object as described above. For example, in the present example, in the case in which a material of a fragment object is a particular material, an in-game effect corresponding to the particular material is produced for the fragment object, and the size of the fragment object is reduced according to game progression. First to sixth examples will be described as to the in-game effect produced by a fragment object.

### First Example

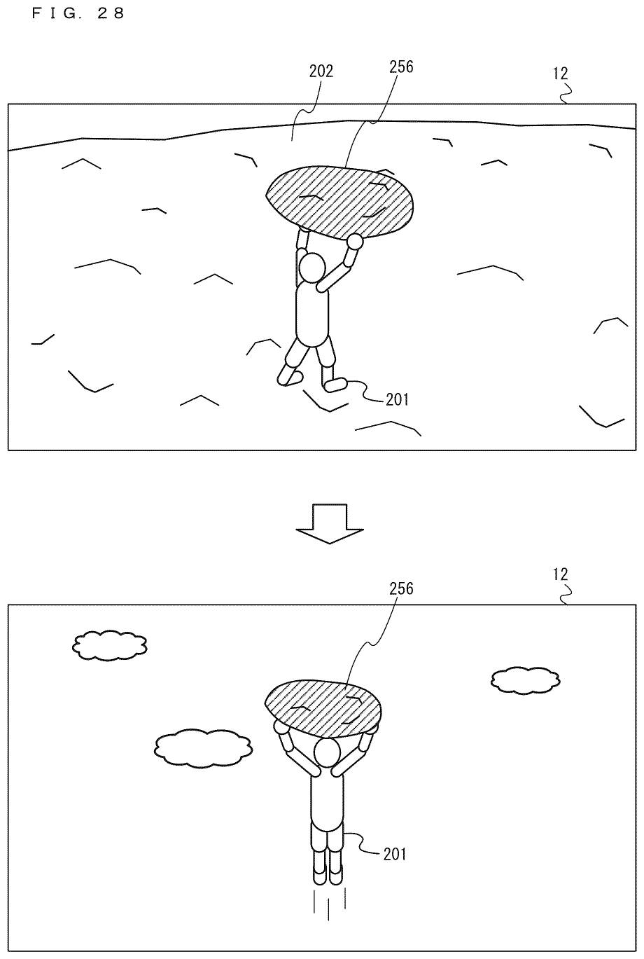

As a first example, an example will be described in which a player character 201 performs an action of flying while holding a fragment object generated as described above (hereinafter referred to as a “flying action”). FIG. 28 is a diagram showing an example of a game image representing a state in which the player character 201 performs the flying action while holding a fragment object 256, in the game space.

In the present example, in the case in which a material of a fragment object removed from a terrain object as described above includes a levitation stone (rocket stone) (the fragment object 256 in FIG. 28), the user can cause the player character 201 to perform the flying action while holding the fragment object 256. It should be noted that, by performing a predetermined operation input, the user can cause the player character 201 to perform an action of lifting up the fragment object 256, which has been generated due to the punching action disposed on a ground. In addition, by performing the pull-out action or an action of holding the fragment object 256 after the punching action, the player character 201 holds the fragment object 256 (see the upper diagram of FIG. 28). In this state, the game system 1 causes the player character 201, which is holding the fragment object 256, to levitate in the air in the game space and rise in a direction depending on the user's operation input, as the flying action, in response to the operation input (see the lower diagram of FIG. 28).

In the first example, in the case in which a material of the fragment object 256 is a levitation stone, the effect of rising in the air is produced for the fragment object 256 as an in-game effect corresponding to the levitation stone. Specifically, when the player character 201 is holding the fragment object 256, a force for rising in the game space is invariably applied to the fragment object 256. Furthermore, when the player character 201, which is holding the fragment object 256, is rising in the air, the user can control the flying direction by performing a predetermined operation input (e.g., an operation input to tilt the analog stick 32 or 52). In addition, when the player character 201, which is holding the fragment object 256, is flying in the air, the user can cause the player character 201 to perform an action of releasing the held fragment object 256, by performing a predetermined operation input (e.g., an operation input to press down the first R-button 60). In addition, the user can cause the player character 201 to perform an action of throwing the held fragment object 256, by performing a predetermined operation input (e.g., an operation input to press down the ZR-button 61). In this case, the player character 201 loses the force for rising in the air that is produced by the fragment object 256, and therefore, falls toward the ground due to gravity acting in the game space. In addition, the effect of rising in the air is ended for the fragment object 256, which has been released from the player character 201, and therefore, the fragment object 256 falls toward the ground due to the gravity acting in the game space.

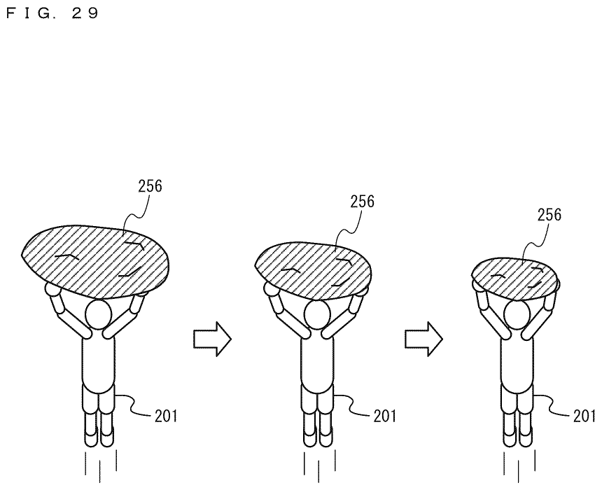

As shown in FIG. 29, the size of the fragment object 256, which has obtained the effect of rising in the air, becomes smaller as time passes during flying. When the size of the fragment object 256 is smaller than a predetermined reference (e.g., 10% of the initial size), the fragment object 256 is deleted from the game space, and the effect of rising in the air is ended. Therefore, even when the player character 201 is holding the fragment object 256, then if the size of the fragment object 256 is smaller than the predetermined reference, the fragment object 256 loses the force for rising in the air.

As described above, when the fragment object 256 is removed from the terrain object, a specific voxel space is defined for the fragment object 256. In the first example, the size of the fragment object 256 as it is when the specific voxel space is defined after the fragment object 256 has been removed as described above is set as its initial size (e.g., 100%), and is reduced at a predetermined ratio by linearly scaling according to the elapsed time for which the effect of rising in the air has been produced. Here, the scaling is a process of reducing the size of the fragment object 256 by reducing the size in the game space of the specific voxel space defined for the fragment object 256. Specifically, the scaling is a process of reducing all voxels included in the specific voxel space at once and thereby reducing the specific voxel space itself. The voxel data of the voxels is not changed.

It should be noted that as described above, the size of the fragment object 256 as it is when removed from the terrain object is set to the initial size, e.g., 100%. This means that the size of the fragment object 256 as it is when removed from the terrain object is set to the initial size that is 100% irrespective of what size the fragment object 256 has at the time when the fragment object 256 is removed from the terrain object (whatever the size of the fragment object 256 is at the time when the fragment object 256 is removed from the terrain object). The size of the fragment object 256 is reduced at a predetermined rate (a predetermined proportion per unit time) by linear scaling with the passage of time during which the effect of rising in the air is produced. As a result, the period of time for which the player character 201 can fly is the same irrespective of what size the fragment object 256 has at the time when the fragment object 256 is removed from the terrain object (whatever the size of the fragment object 256 is at the time when the fragment object 256 is removed from the terrain object). It should be noted that in the first example, when the player character 201 releases the fragment object 256 in the middle of flying, the fragment object 256 is disposed in the game space in a state that the size of the fragment object 256 has been consumed (e.g., reduced) according to the period of time for which the fragment object 256 has flown until the time of the release. Thereafter, when the player character 201 holds the fragment object 256, which has a reduced size, again, the player character 201 can obtain the effect of rising in the air produced by the fragment object 256 until the remaining size is further reduced from the reduced size to be smaller than the predetermined reference. At this time, if the remaining size of the fragment object 256 is smaller than the initial size, the flight time for which the player character 201 can obtain the effect of rising in the air produced by the fragment object 256 is shorter than in the case of the initial size.

Thus, in the first example, in the case in which a material of a fragment object is a levitation stone, the effect of rising in the air is produced for the fragment object as an in-game effect corresponding to the levitation stone, and the size of the fragment object is reduced with the passage of the flight time. As a result, a player character can be caused to perform an action of removing a fragment object from a terrain object, and the effect that is produced by consumption of the removed object, depending on the material of the object.

Although in the foregoing description of the first example, the player character 201 can obtain an in-game effect produced by the fragment object 256 by holding the fragment object 256, the embodiment in which the player character 201 obtains the in-game effect is not particularly limited. For example, when the player character 201 gets on the fragment object 256 based on a predetermined operation input (e.g., an operation input to press down the ZL-button 39), the fragment object 256 may produce the effect of rising in the air, which may be obtained by the player character 201.

In addition, although in the foregoing description of the first example, the size of the fragment object 256, which has obtained the effect of rising in the air, becomes smaller with the passage of the flight time, the size of the fragment object 256 may be changed based on other parameters. For example, the size of the fragment object 256 may become smaller according to the flight distance or rise distance of the fragment object 256. In that case, when the player character 201, which is using the fragment object 256, is staying and hovering in the air, the size of the fragment object 256 is not reduced or consumed, and therefore, the player character 201 can stay in the air for a relatively long period of time. In addition, the size of the fragment object 256, which has obtained the effect of rising in the air, may be reduced in a stepwise manner. In that case, the size of the fragment object 256, which has obtained the effect of rising in the air, may be reduced by the scaling each time the flight time, flight distance, rise distance, or the like reaches one of predetermined thresholds.

In addition, although in the foregoing description of the first example, the size of the fragment object 256, which has obtained the effect of rising in the air, is reduced at a predetermined ratio, the size of the fragment object 256 may be reduced in other ways. As an example, when the above effect is obtained, the size of the fragment object 256 may be reduced in predetermined amounts. In that case, the duration or distance for which the player character 201 can obtain the above effect is increased with an increase in the size of the fragment object 256 removed from the terrain object, and therefore, variations of the effect obtained by the size of the fragment object 256 used by the player character 201 can be increased. As another example, the size of the fragment object 256 may be reduced in predetermined proportions or amounts according to the number of times the above effect has been obtained (e.g., the number of times the fragment object 256 has flown). In addition, the maximum flight time, maximum flight distance, maximum rise distance, and the like provided by using the fragment object 256 may be increased or decreased, depending on the type of a material of the fragment object 256, the method by which the player character 201 uses the fragment object 256, the capability of the player character 201, or the like.

In addition, although in the foregoing description of the first example, the effect of rising in the air is produced for the fragment object 256, other effects may be produced. For example, in the case in which a material of the fragment object 256 is a levitation stone, the effect of allowing the fragment object 256 to fly freely may be produced as an in-game effect corresponding to the levitation stone, and the size of the fragment object may be reduced with the passage of time when the fragment object is flying.

### Second Example

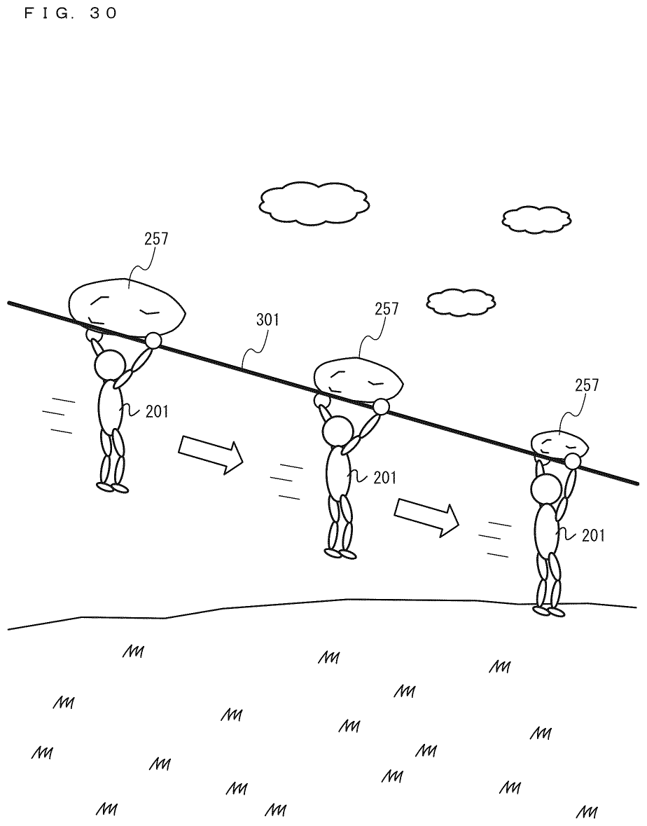

As a second example, an example will be described in which a player character 201 performs an action of gliding on a predetermined path set in the game space while holding a fragment object as described above (hereinafter referred to as a “gliding action”). FIG. 30 is a diagram showing an example of a game image representing a state in which the player character 201 performs the gliding action along a wire rope 301 provided in the game space while holding a fragment object 257.

In the present example, in the case in which a material of a fragment object removed from a terrain object as described above includes a material that can be held by the player character 201 (the fragment object 257 of FIG. 30), the user can cause the player character 201 to perform the gliding action with the player character 201 holding the fragment object 257. Here, for the material that can be held, a property that the material can be removed from a terrain object that is a voxel object, and a property that the material has such a hardness that the material keeps the shape thereof for a predetermined period of time, are set as property information included in the material data. For example, the material that can be held includes solid materials such as rock, soil, sand, wood, concrete, metal, and rock plate, excluding materials having a liquid property and materials that have a property that the hit points of a player character are significantly reduced when the player character is in contact with the material. It should be noted that as described above, the player character 201 is caused to have the fragment object 257 by performing the pull-out action or an action of holding the fragment object 257 after the punching action. In this state, according to the user's operation input, the game system 1 causes the player character 201 to perform the gliding action to move on the wire rope 301 by hanging from the wire rope 301, which is provided by utilizing a difference in height of a terrain in the game space, while holding the fragment object 257.

In the second example, in the case in which a material of the fragment object 257 is the material that can be held, the effect of moving on a predetermined path (the wire rope 301) provided in the game space is produced for the fragment object 257 as an in-game effect corresponding to the material. Specifically, when the player character 201 is hanging from the wire rope 301 while holding the fragment object 257, the force that causes the fragment object 257 to glide along the wire rope 301 is invariably applied to the fragment object 257. When the player character 201 is gliding while holding the fragment object 257, the user can increase/decrease the gliding speed by performing a predetermined operation input (e.g., an operation input to tilt the analog stick 32 or 52). In addition, when the player character 201 is gliding while holding the fragment object 257, the user can perform motion control to cause the player character 201 to temporarily leave and jump from the wire rope 301, by performing a predetermined operation input (e.g., an operation input to press down the A-button 53). In addition, the user can perform motion control to cause the player character 201 to release the fragment object 257, which has been being held by the player character 201, to leave the wire rope 301, by performing a predetermined operation input (e.g., an operation input to press down the ZL-button 39). In addition, the user can perform motion control to cause the player character 201 to perform a jumping action to leave the wire rope 301, by performing a predetermined operation input (e.g., an operation input to press down the A-button 53).

As shown in FIG. 30, the size of the fragment object 257, which has obtained the effect of gliding on the wire rope 301, is reduced according to the distance over which the fragment object 257 has glided. When the size of the fragment object 257 is smaller than a predetermined reference, the fragment object 257 is deleted from the game space and the gliding effect is ended. Therefore, when the size of the fragment object 257 is smaller than the predetermined reference during the gliding, the player character 201 loses the force that allows the gliding on the wire rope 301, and falls from the wire rope 301.

Also in the second example, as in the first example, the state of the fragment object 257 as it is when the fragment object 257 is removed as described above and a specific voxel space is defined is set as its initial size, and the size of the fragment object 256 is reduced at a predetermined ratio by linear scaling according to the gliding distance over which the gliding effect has been produced (specifically, a parameter obtained by multiplication of the gliding speed and the gliding time). Therefore, in the second example, the size of the fragment object 257 is not reduced when the player character 201 just holds the fragment object 257, or during a period of time when the player character 201 is temporarily off the wire rope 301 after jumping during the gliding action, or during a period of time after the gliding action is ended by the player character 201 leaving the wire rope 301 by releasing the fragment object 257.

In addition, in the second example, the size of the fragment object 257 is reduced based on the hardness of a material of the fragment object 257 in addition to the gliding distance. Specifically, the ratio at which the size of the fragment object 257 is reduced is increased with a decrease in the hardness of the material of the fragment object 257. As a result, when the hardness of the material of the fragment object 257 is small, the gliding distance over which the player character 201 can obtain the effect of gliding using the fragment object 257 is shorter than when the hardness of the material is great. In addition, if the material of the fragment object 257 has such a hardness that the material cannot be destroyed, the size of the fragment object 257 may not be reduced. Therefore, variations of the effect can be increased by increasing the types of materials of the fragment object 257 used by the player character 201.

Thus, in the second example, in the case in which a material of a fragment object can be held by the player character 201, the effect of allowing the fragment object to glide on a predetermined path is produced as an in-game effect corresponding to the material, and the size of the fragment object is reduced according to gliding distance. As a result, a player character can be caused to perform an action of removing a fragment object from a terrain object, and the effect that is produced by consumption of the removed object can be produced, depending on a material of the object.

Although in the foregoing description of the second example, the size of the fragment object 257, which has obtained the gliding effect, is reduced according to the gliding distance of the fragment object 257, the size of the fragment object 257 may be changed based on other parameters. For example, the size of the fragment object 256 may be reduced according to the gliding time of the fragment object 257. In addition, the size of the fragment object 257, which has obtained the gliding effect, may be reduced in a stepwise manner. In that case, the size of the fragment object 257, which has obtained the gliding effect, may be reduced by the scaling each time the gliding distance, gliding time, or the like of the fragment object 257 reaches one of predetermined thresholds.

In addition, although in the foregoing description of the second example, the size of the fragment object 257, which has obtained the gliding effect, is reduced at a predetermined ratio, the size of the fragment object 257 may be reduced in other ways. For example, as in the first example, the size of the fragment object 257 may be reduced in a predetermined amount each time the effect is obtained. Alternatively, the size of the fragment object 257 may be reduced in predetermined proportions or amounts according to the number of times the above effect has been obtained (e.g., the number of times the fragment object 256 has glided). In addition, the maximum gliding distance, maximum gliding time, and the like provided by using the fragment object 257 may be increased or decreased, depending on the type of a material of the wire rope 301, the capability of the player character 201, or the like.

### Third Example

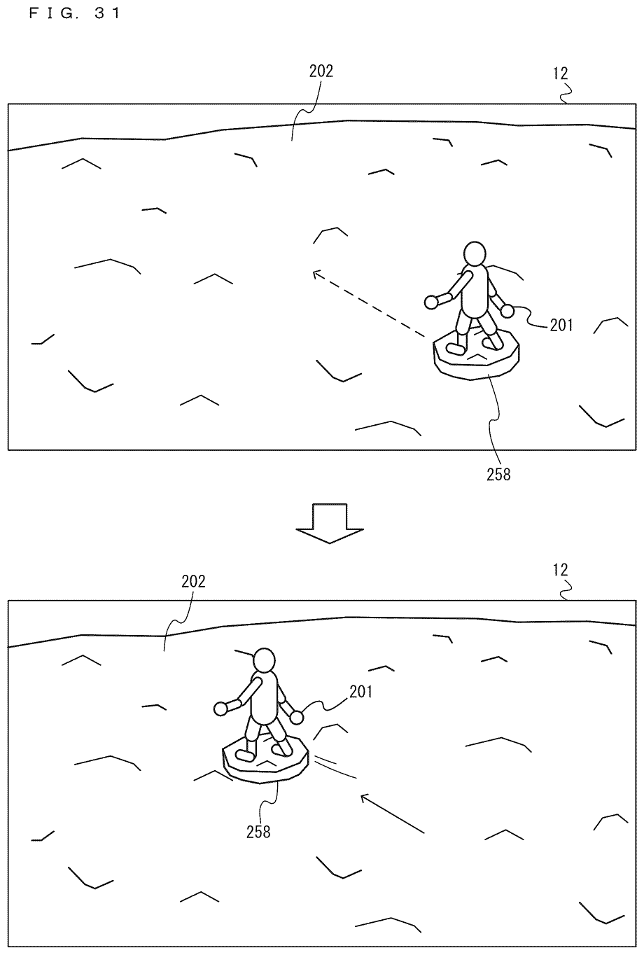

As a third example, an example will be described in which a player character 201 performs an action of moving on a terrain object (hereinafter referred to as a “moving action”) while sitting on a fragment object generated as described above. FIG. 31 is a diagram showing an example of a game image representing a state in which the player character 201 performs the moving action while sitting on a fragment object 258, in the game space.

In the present example, in the case in which a material of a fragment object removed from a terrain object as described above includes a material on which the player character 201 can sit (the fragment object 258 of FIG. 31), the user can cause the player character 201 to perform the moving action of moving on the terrain object while sitting on the fragment object 258. Here, for the material on which the player character 201 can sit, a property that the material can be removed from a terrain object that is a voxel object, and a property that the material has such a hardness that the player character 201 can sit on the material without sinking into the fragment object, are set as property information included in the material data. For example, the material on which the player character 201 can sit includes solid materials such as rock, soil, sand, wood, concrete, metal, and rock plate, excluding materials having a liquid property and materials that have a property that the hit points of a player character are significantly reduced when the player character is in contact with the material. It should be noted that the user can cause the player character 201 to sit on a fragment object 258 that has been generated due to the punching action and disposed on a ground. In addition, the user can cause the player character 201 to perform an action of getting on a fragment object 258 that has been removed due to the pull-out action and disposed on the terrain object (see the upper diagram of FIG. 31). In this state, according to the user's operation input, the game system 1 causes the player character 201 to perform the moving action of moving on the terrain object 202 while sitting on the fragment object 258 (see the lower diagram of FIG. 31).

In the third example, in the case in which a material of the fragment object 258 is the material that the player character 201 can sit on, the effect of moving the player character 201, which is sitting on the fragment object 258, on the terrain object 202 based on the user's operation input, is produced for the fragment object 258 as an in-game effect corresponding to the material. Specifically, when the player character 201 is sitting on the fragment object 258, the force that moves the fragment object 258 on the terrain object 202 is applied to the fragment object 258. The user can control the movement direction or movement speed of the fragment object 258 by performing a predetermined operation input (e.g., an operation input to tilt the analog stick 32 or 52) when the player character 201 is sitting on the fragment object 258. In addition, by performing a predetermined operation input (e.g., an operation input to press down the A-button 53), the user can cause the player character 201 to perform an action of jumping when the player character 201 is sitting on the fragment object 258. In addition, by performing a predetermined operation input (e.g., an operation input to press down the ZL-button 39), the user can cause the player character 201 to perform an action of getting off the fragment object 258 when the player character 201 is sitting on the fragment object 258. In this case, the player character 201 loses the force with which the fragment object 258 moves the player character 201, so that the player character 201 lands on the position where the player character 201 gets off the fragment object 258. In addition, the fragment object 258, which the player character 201 has got off, loses the effect of moving on the terrain object 202, and therefore, stops moving at the position where the player character 201 has got off.

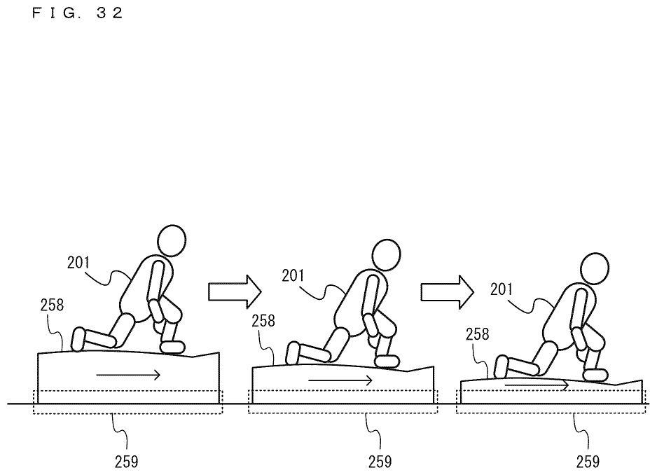

As shown in FIG. 32, the size of the fragment object 258, which has obtained the effect of moving on the terrain object 202, is reduced according to movement distance. When the size of the fragment object 258 is smaller than a predetermined reference, the fragment object 258 is deleted from the game space, and the effect of moving is ended. For example, in the third example, as described below, the size of the fragment object 258 becomes smaller as the thickness thereof becomes thinner according to movement distance. In this case, when the thickness of the fragment object 258 is smaller than a predetermined reference, the game system 1 may delete the fragment object 258 from the game space and end the effect of moving. It should be noted that in the third example, the consumption of the fragment object 258 depends on movement distance, and therefore, the consumption of the fragment object 258 that reduces the size of the fragment object 258 does not proceed, if the player character 201 is not moving on the terrain object 202 even when the player character 201 is sitting on the fragment object 258. Thus, in the third example, the size of the fragment object 258 is reduced as a compensation for an in-game effect obtained by the fragment object 258.

As described above, for the fragment object 258 removed from the terrain object, a specific voxel space is defined when the fragment object 258 is removed. In the third example, an update range for the fragment object 258 is set at a position in the game space based on the position of the terrain object 202, and the size of the fragment object 258 is reduced by decreasing the densities of voxels corresponding to the update range in the voxel data for the fragment object 258.

For example, as shown in FIG. 32, when the fragment object 258 moves with at least a portion of the lower surface of the fragment object 258 in contact with the surface of the terrain object 202, an update range 259 that is in the shape of a thin plate including at least the entire lower surface of the fragment object 258 is set in the specific voxel space with reference to the contact position. Thereafter, as described above, an SDF corresponding to the update range 259 is set, and the density of each voxel in the fragment object 258 is rewritten based on the SDF of the voxel, whereby deletion of each voxel is controlled. As a result, the fragment object 258 is deformed such that a lower surface portion of the fragment object 258 corresponding to the update range 259 is deleted, so that the fragment object 258 is partially cut away from the lower surface, resulting in a reduction in the thickness, and therefore, the size of the fragment object 258 is reduced.

In the third example, the process of partially cutting away the lower surface based on the update range 259 is executed each time a parameter based on the effect of moving reaches one of predetermined cumulative amounts. For example, in the examples of FIGS. 31 and 32, the process of partially cutting away the lower surface of the fragment object 258 is executed in a stepwise manner, e.g., each time the movement distance of the fragment object 258, on which the player character 201 is sitting, reaches one of predetermined movement distances (e.g., thresholds for execution of the cutting-away process).

It should be noted that as a first example, the lower surface of the fragment object 258 may be partially cut away by a predetermined thickness, by execution of the cutting-away process. In that case, the distance over which the fragment object 258, on which the player character 201 is sitting, can move depends on the thickness of the fragment object 258 as it is when removed from the terrain object, and therefore, increases with an increase in the thickness of the fragment object 258 as it is when removed from the terrain object. As a second example, by execution of the cutting-away process, the lower surface of the fragment object 258 is cut away in a cut-away amount based on a proportion with respect to the whole. In that case, the distance over which the fragment object 258, on which the player character 201 is sitting, can move does not depend on the size (thickness) of the fragment object 258 as it is when removed from the terrain object, and is the same irrespective of the size of the fragment object 258 as it is when removed from the terrain object. As a third example, by execution of the cutting-away process, the lower surface of the fragment object 258 may be cut away in a predetermined volume amount. In that case, the distance over which the fragment object 258, on which the player character 201 is sitting, can move depends on the size of the fragment object 258 as it is when removed from the terrain object, and increases with an increase in the size of the fragment object 258 as it is when removed.

In addition, in the third example, in any of the first to third examples, the proportion, thickness, or amount of the lower surface of the fragment object 258 that is cut away by the cutting-away process being executed once is changed based on the hardness of the material of the fragment object 258. Specifically, the cut-away proportion, cut-away thickness, or cut-away amount is increased with a decrease in the hardness of the material of the fragment object 258. As a result, in the case in which the hardness of the material the fragment object 258 is low, the movement distance over which the player character 201 can obtain the effect of moving using the fragment object 258 is shorter than in the case in which the hardness of the material is high. Therefore, variations of the effect provided by different types of materials of the fragment object 258 used by the player character 201 can be increased.

In addition, in the third example, when the player character 201, which is sitting on the fragment object 258, performs a jumping action, the process of partially cutting away the lower surface of the fragment object 258 may be executed at least once due to the impact that occurs when the player character 201 lands on the terrain object 202 after the jumping. For example, the amount of the lower surface of the fragment object 258 that is cut away due to the jumping may be determined based on the height over which the player character 201 has jumped, and may be increased with an increase in the impact force that occurs when the player character 201 lands on the ground (e.g., an increase in the height over which the player character 201 has jumped). It should be noted that in the third example, when the player character 201 gets off the fragment object 258 in the middle of movement, the fragment object 258 is disposed in the game space with the size thereof consumed and reduced depending on the movement distance over which the fragment object 258 has moved until that time. Thereafter, when the player character 201 gets on the fragment object 258, which has been thus reduced, and moves again, the player character 201 can obtain the effect of moving produced by the fragment object 258 until the remaining size of the fragment object 258, which has been reduced, is smaller than a predetermined reference. At this time, the movement distance over which the player character 201 can obtain the effect of moving produced by the fragment object 258, which has been reduced, is shorter because of the movement distance over which the fragment object 258 has already moved until the fragment object 258 has the reduced size.

Thus, in the third example, in the case in which a material of a fragment object is the material that a player character can sit on, the effect of moving on a terrain object is produced for the fragment object as an in-game effect corresponding to the material, and the size of the fragment object is reduced according to movement distance. As a result, a player character can be caused to perform an action of removing a fragment object from a terrain object, and the effect that occurs due to consumption of the object can be produced, depending on a material of the removed object.

Although in the foregoing description of the third example, the size of the fragment object 258, which has obtained the effect of moving on a terrain object, is reduced according to the movement distance of the fragment object 258, the size of the fragment object 258 may be changed based on other parameters. As an example, the size of the fragment object 258 may be reduced according to the period of time for which the fragment object 258 has moved or has been used. As another example, the size of the fragment object 258 may be reduced such that the fragment object 258 is thinned in predetermined proportions, thicknesses, or amounts according to the number of times the effect has been obtained (e.g., the number of times of movement). In addition, the maximum movement distance or the like of a player character using the fragment object 258 may be increased or decreased, depending on a material of an object that the fragment object 258 comes into contact with during movement, the shape of a surface of an object that the fragment object 258 comes into contact with during movement, the capability of the player character 201, or the like.

### Fourth Example

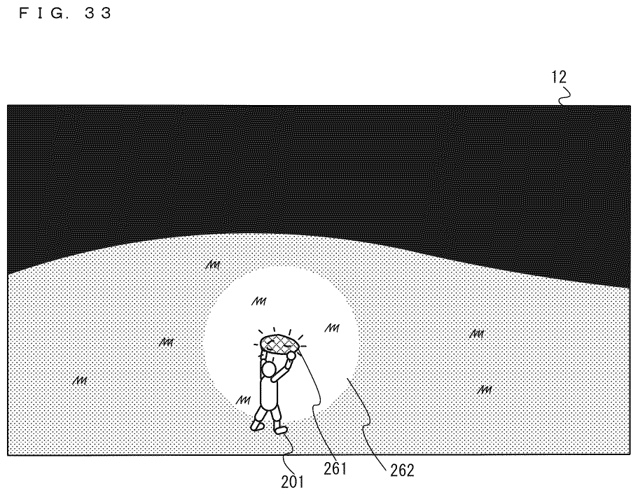

As a fourth example, an example will be described in which a light source is set at the position in the game space of a fragment object generated as described above, and an action of illuminating the game space with light is performed. FIG. 33 is a diagram showing an example of a game image representing a state in which a player character 201 performs an action of illuminating the game space with light while holding a fragment object 261.

In the present example, in the case in which a material of a fragment object removed from a terrain object as described above includes a light stone (the fragment object 261 of FIG. 33), the user can cause the player character 201 to perform an action of setting a light source at the position of the fragment object 261 and providing light while holding the fragment object 261. It should be noted that as described above, the player character 201 holds the fragment object 261 when the player character 201 performs the pull-out action or the action of holding the fragment object 261 after performing the punching action. In this state, the game system 1 sets a light source at the position of the fragment object 261, which is being held by the player character 201, and forms a range 262 in which the game space is illuminated.

In the fourth example, in which a material of the fragment object 261 is a light stone, the effect of setting a light source at the position of the fragment object 261 in the game space is produced for the fragment object 261 as an in-game effect corresponding to the light stone. For example, the game system 1 sets a disposed light at the position of the fragment object 261. As an example, the game system 1 sets a point light that emits light radially from the surface of the fragment object 261 in the game space, and forms a range 262 that light of the point light reaches. The range 262 that light reaches may be set in any shape, such as a spherical, ellipsoidal, conical, or cylindrical shape, depending on the type or property of the light source.

It should be noted that in the range 262 that is formed by the fragment object 261 and that light reaches, a predetermined effect may be produced in addition to lighting of the game space. For example, when another object (e.g., an enemy object formed of a voxel object) is located in the range 262 that light reaches, a material of the another object may be changed. For example, when another object formed of a material A is located in the range 262 that is formed by the fragment object 261 and that light reaches, from the outside of the range 262 that light reaches, the another object formed of a material A may be changed to still another object formed of a material B.

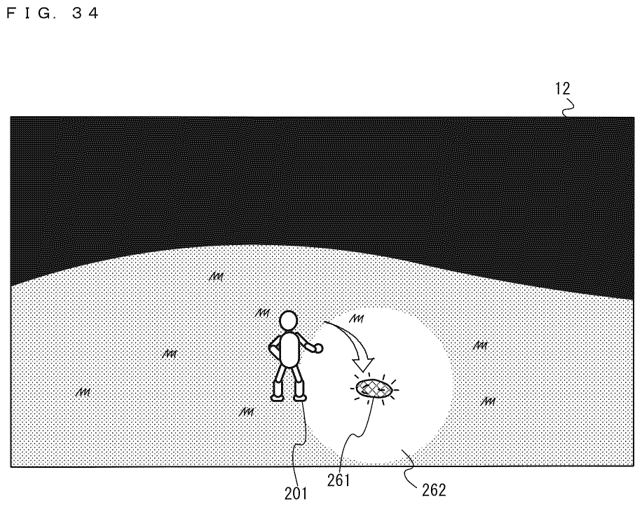

In the fourth example, light is invariably emitted radially from the surface of the fragment object 261 irrespective of whether or not the player character 201 is holding the fragment object 261. For example, the user can cause the player character 201 to perform an action of throwing the fragment object 261, which is being held by the player character 201, by performing a predetermined operation input (e.g., an operation input to press down the ZR-button 61). As shown in FIG. 34, even when the player character 201 performs an action of throwing the fragment object 261 onto a terrain object, so that the fragment object 261 is disposed on the terrain object, a state in which light is emitted radially from the surface of the fragment object 261 is maintained, and the range 262 that light reaches continues to be formed.

The size of the fragment object 261, which is emitting light, is reduced with the passage of time when light is being emitted. When the size of the fragment object 261 is smaller than a predetermined reference, the effect of emitting light from the fragment object 261 is ended, and the fragment object 261 is deleted from the game space.

In the fourth example, as in the first and second examples, the size of the fragment object 261 is also reduced at a predetermined ratio by linear scaling according to the elapsed time for which the effect of emitting light has been produced, where the state of the fragment object 261 as it is when the fragment object 261 is removed and a specific voxel space is defined is set as its initial size.

Thus, in the fourth example, in the case in which a material of a fragment object is a light stone, the effect of setting a light source at the position of the fragment object is produced for the fragment object as an in-game effect corresponding to the light stone, and the size of the fragment object is reduced according to the elapsed time for which the light source has been set. As a result, a player character can be caused to perform an action of removing a fragment object from a terrain object, and the effect produced by consumption of the removed object can be produced, depending on a material of the removed object.

It should be noted that in the foregoing description of the fourth example, the size of the fragment object 261, which has obtained the effect of emitting light, may also be reduced in a stepwise manner. In this case, the reduction may be performed by the scaling each time the elapsed time for which the fragment object 261 emits light reaches one of predetermined thresholds.

In addition, although in the foregoing description of the fourth example, the size of the fragment object 261, which has obtained the effect of setting a light source, is reduced at a predetermined ratio, the size of the fragment object 261 may be reduced in other ways. For example, as in the first and second examples, the size of the fragment object 261 may be reduced in a predetermined amount each time the above effect is obtained.

### Fifth Example

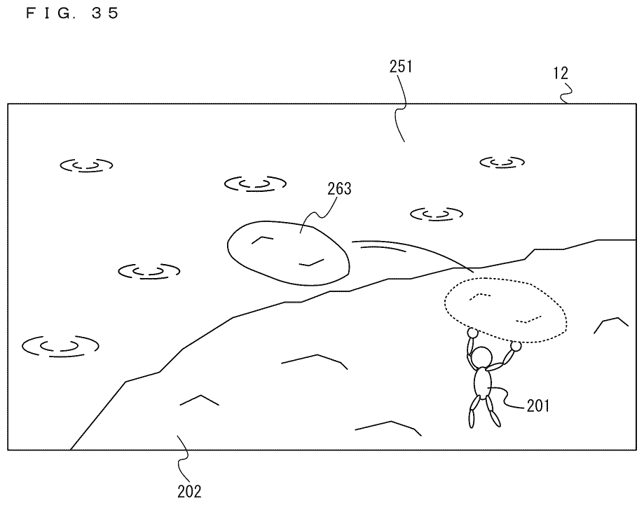

As a fifth example, an example will be described in which an action of changing a material of another voxel object is performed for a fragment object generated in the game space as described above. FIGS. 35 to 37 are a diagram showing an example of a game image representing a state in which a player character 201 throws a fragment object 263 into a region 251 of a terrain object.

In the present example, in the case in which a material of a fragment object removed from a terrain object as described above includes ice (the fragment object 263 of FIGS. 35 to 37), the user can change a material in the region 251 by performing an action of throwing the fragment object 263 into the region 251 of the terrain object. It should be noted that as described above, the player character 201 is caused to hold the fragment object 261 by performing the pull-out action or an action of holding the fragment object 263 after the punching action. As shown in FIG. 35, the user can cause the player character 201 to perform an action of throwing the fragment object 263, which is being held by the player character 201, by performing a predetermined operation input (e.g., an operation input to press down the B-button 54). As a result, the fragment object 263 moves in the game space based on the direction in which the player character 201 has performed the throwing action.

As described above, a specific voxel space that is independent of the voxel space of voxels corresponding to the terrain object 202 or the like is defined for the fragment object 263. The specific voxel space can be moved/rotated in the game space along with the fragment object 263, for which the specific voxel space is defined, and the position, direction (orientation), and the like of the specific voxel space in the game space are controlled. In addition, an ice material is set as materials of polygons of the fragment object 263. Regarding the ice material, it is assumed that the property of reducing the temperature of an object that ice has come into contact with is set as property information included in the aforementioned material data (e.g., the property of having a temperature equal to or lower than a predetermined value (e.g., a temperature equal to or lower than the ice point)). Materials of a specific display mesh and a specific determination mesh of the fragment object 263 are determined based on the voxel material using the aforementioned method for determining materials of a display mesh and a determination mesh.

In the fifth example, when it is determined as a result of collision determination that the fragment object 263, which has been thrown by the player character 201 performing the throwing action, has come into contact with a voxel object, the game system 1 makes a change the voxel object as an in-game behavior.

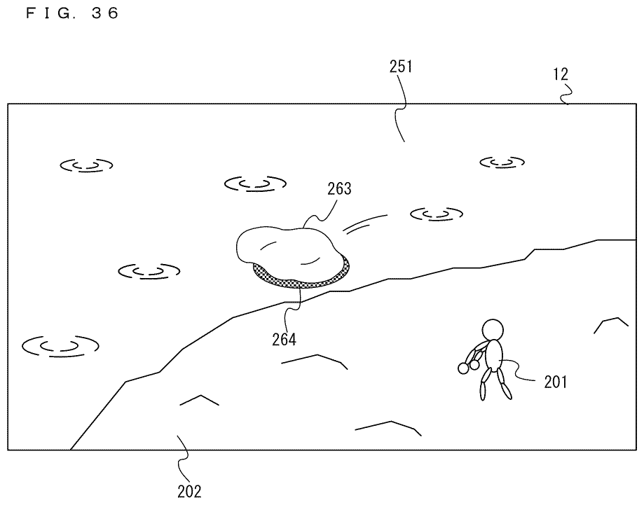

In the example of FIG. 36, a portion of the region 251 formed of the lava material of the terrain object is changed such that the material at and near the position of the region 251 of the terrain object at which the fragment object 263 has come into contact with the region 251 for the first time is cooled by the fragment object 263 to be changed. Specifically, the game system 1 generates an update range including the contact position, and changes materials of voxels of the terrain object in the update range, to change a portion of the region 251 of the terrain object. In addition, the size of the fragment object 263 is reduced by the scaling such that the fragment object 263 is melted due to contact with the region 251 formed of the lava material.

For example, the update range is set to a shape corresponding to a shape with which the fragment object 263 has come into contact with the terrain object for the first time, and the lava material of voxels of the terrain object in the update range is changed to the obsidian material. Specifically, for the voxels in the update range corresponding to the region 251 of the terrain object, the lava material is changed to the obsidian material. Thereafter, materials of a display mesh and a determination mesh of the terrain object are determined based on the changed materials of the voxels. In FIG. 36, a portion of the region 251 that has been changed to the obsidian material is set as a region 264. Thus, of the region 251 of the terrain object that had the lava material, the region 264 in which the material has been changed to the obsidian material can be caused to have an appearance different from that of the region 251 of the lava material. Therefore, the user is more likely to get an impression that the fragment object 263 has cooled and degenerated the lava material of the region 251 of the terrain object. This can represent the situation that a lava object is changed to obsidian by being cooled by the fragment object 263, which is formed of an ice object.

In addition, the size of the fragment object 263 is reduced according to the elapsed time for which the fragment object 263 has been in contact with the region 251 formed of the lava material. When the size of the fragment object 263 is smaller than a predetermined reference, the effect of cooling the region 251 formed of the lava material by the fragment object 263 is ended, and the fragment object 263 is deleted from the game space.

In the fifth example, as in the first, second, and fourth examples, the size of the fragment object 263 is reduced at a predetermined ratio by linear scaling according to the elapsed time for which the effect of cooling the region 251 formed of the lava material has been produced, where the state of the fragment object 263 as it is when the fragment object 263 is removed as described above and a specific voxel space is defined is set as its initial size. As a result, because the size of the fragment object 263 is reduced, the user is more likely to get an impression that the fragment object 263, which is formed of the ice material, is melt by the lava material of the region 251 of the terrain object.

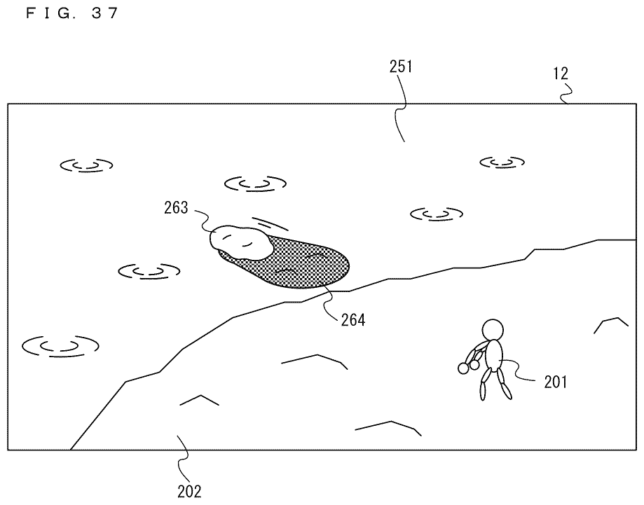

In the example of FIG. 37, the fragment object 263 has been further moved on the terrain object from the position shown in FIG. 36 while being in contact with the region 251 of the terrain object. The region 251 of the terrain object is changed such that the material at and near additional contact positions due to the movement is cooled and changed by the fragment object 263. In addition, the size of the fragment object 263 is reduced such that the fragment object 263 is further melted due to additional contact with the region 251 of the terrain object. Specifically, by a method similar to the aforementioned method for changing a material, the game system 1 generates a new update range that includes additional contact positions with the reduced fragment object 263, and further changes materials of voxels of the terrain object in the new update range, thereby further changing a portion of the region 251 of the terrain object. Specifically, the game system 1 reduces the new update range according to the size of the fragment object 263, which has been reduced by the scaling. It should be noted that the game system 1 generates the new update range such that the new update range is continuously linked to the previously generated update range. As a result, a region in which a material is changed and that is extended each time an update range is generated is continuously linked to a region in which the material has already been changed (e.g., the region 264 of FIG. 37). In addition, the game system 1 further reduces the size of the fragment object 263 using a method similar to the scaling. As a result, the region 264 of the terrain object in which the lava material is changed to an obsidian material can be further extended. Therefore, the user is more likely to get an impression that the fragment object 263 further cools and degenerates the lava material of the region 251 of the terrain object, so that the degenerated region is increased. In addition, because the size of the fragment object 263 is further reduced, the user is more likely to get an impression that the fragment object 263 has further melted the lava material of the region 251 of the terrain object.

It should be noted that the details of the aforementioned material change may be determined based on a material of a contacted terrain object or based on the combination of a material of a contacted terrain object and a material of a contacted fragment object. This allows various changes in voxel objects constituting a terrain object or a fragment object.

Thus, in the fifth example, in the case in which a material of a fragment object is ice, then if materials of voxels in the voxel data of a terrain object corresponding to an update range based on the position of the fragment object are the lava material, the effect of changing the lava material to the obsidian material is produced for the fragment object as an in-game effect corresponding to the ice, and the size of the fragment object is reduced with the passage of time when the material is being changed. As a result, a player character can be caused to perform an action of removing a fragment object from a terrain object, and the effect that is caused due to consumption of the removed object can be produced, depending on a material of the object.

It should be noted that in the fifth example, the size of the fragment object 263, which has obtained the effect of changing a material, may also be reduced in a stepwise manner material. In that case, the reduction may be performed by the scaling each time the elapsed time for which the fragment object 263 has changed a material reaches one of predetermined thresholds.

In addition, although in the foregoing description of the fifth example, the size of the fragment object 263, which has obtained the effect of setting a light source, is reduced at a predetermined ratio, the size of the fragment object 263 may be reduced in other ways. For example, as in the first, second, and fourth examples, the size of the fragment object 263 may be reduced in a predetermined amount each time the aforementioned effect is obtained.

It should be noted that the details of the material change in the fifth example may be determined based on a material of a contacted terrain object, a material of the contacted fragment material 263, or based on the combination of the material of the contacted terrain object and the material of the contacted fragment object 263. This allows various changes in voxel objects constituting a terrain object or the fragment object 263.

In the fifth example, when the fragment object 263 comes into contact with another voxel object, a material of the another voxel object is changed. What of the another voxel object should be changed is not limited to this. The densities of voxels of the another voxel object may be changed. For example, when the fragment object 263 comes into contact with the region 251 of the terrain object formed of the lava material, the densities of voxels of the lava material may be reduced. As a result, a situation can be represented in which a portion of a terrain object formed of the lava material is cooled and reduced by the fragment object 263 formed of the ice material being in contact therewith.

### Sixth Example

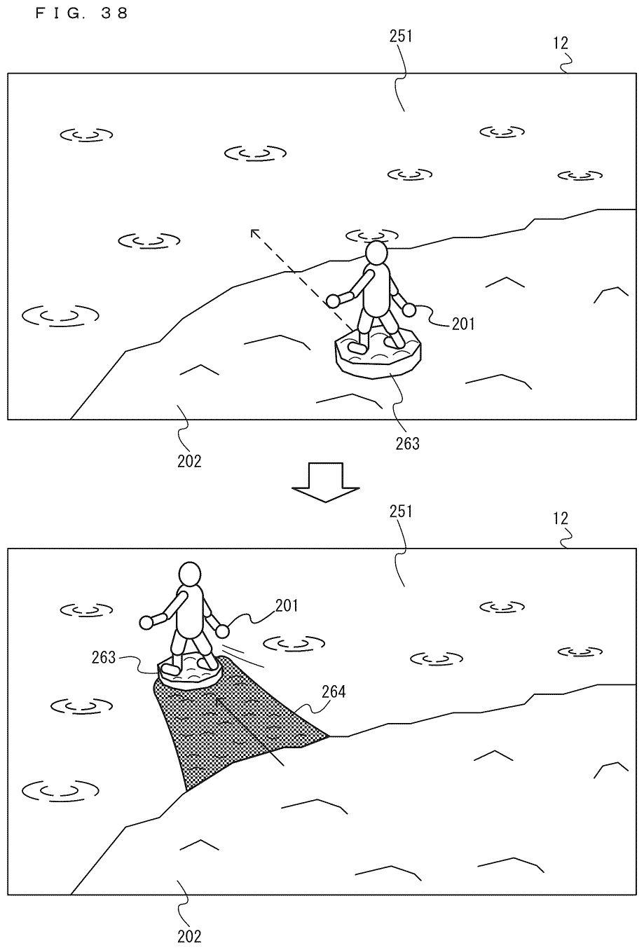

As a sixth example, an example will be described in which a player character performs a moving action of moving on a terrain object while sitting on a fragment object generated as described above, and performs an action of changing a material of another voxel object while performing the moving action. FIG. 38 is a diagram showing an example of a game image representing a state in which a player character 201 performs an action of moving into a region 251 of a terrain object while sitting on a fragment object 263 in the game space.

In the present example, a material of a fragment object removed from a terrain object as described above includes ice (the fragment object 263 of FIG. 38), and a specific voxel space is defined for the fragment object. The user can cause the player character 201 to perform a moving action of moving on a terrain object while sitting on the fragment object 263, whose material is ice. As described above in the third example, the ice material allows a player character to sit thereon. In addition, as described above in the fifth example, regarding the ice material, it is assumed that the property of reducing the temperature of an object that ice has come into contact with is set as property information included in the aforementioned material data (e.g., the property of having a temperature equal to or lower than a predetermined value (e.g., a temperature equal to or lower than the ice point)). Materials of a specific display mesh and a specific determination mesh of the fragment object 263 are determined based on the voxel material using the aforementioned method for determining materials of a display mesh and a determination mesh.

As in the fifth example, the user can cause the player character 201 to perform an action of sitting on the fragment object 263, by performing a predetermined operation input (see the upper diagram of FIG. 38). In this state, the game system 1 causes the player character 201 to perform an action of moving on the terrain object 202 in a movement direction depending on the user's operation input, as the moving action depending on the operation input, with the player character 201 sitting on the fragment object 263 (see the upper and lower diagrams of FIG. 38).

In the sixth example, in the case in which a material of the fragment object 263 is the ice material, which allows a player character to sit thereon, the game system 1 produces the effect of causing the player character 201, which is sitting on the fragment object 263, to move on the terrain object 202, as an in-game effect corresponding to the material, based on the user's operation input, and when it is determined as a result of collision determination involved with the movement that the fragment object 263 has come into contact with another voxel object, produces the effect of changing a material of the another voxel object for the fragment object 263 as an in-game behavior. Specifically, when the player character 201 is sitting on the fragment object 263, the force that moves the fragment object 263 on the terrain object 202, which includes the region 251, is applied to the fragment object 263. The user can control the movement direction and movement speed of the fragment object 263 by performing a predetermined operation input when the player character 201 is sitting on the fragment object 263.

As in the third example, the size of the fragment object 263, which has obtained the effect of moving on the terrain object 202, is reduced as the lower surface thereof is partially cut away according to movement distance. Specifically, when the fragment object 263 moves on the terrain object 202 outside the region 251, an update range that is in the shape of a thin plate including at least the entire lower surface is set in the specific voxel space of the fragment object 263 with reference to the position where the fragment object 263 is in contact with the terrain object 202. Thereafter, as described above in the third example, an SDF corresponding to the update range is set, and the density of each voxel in the fragment object 263 is rewritten based on the SDF of the voxel, whereby deletion of each voxel is controlled. As a result, the fragment object 263 is deformed such that a lower surface portion of the fragment object 258 corresponding to the update range is deleted, so that the fragment object 263 is partially cut away from the lower surface, resulting in a reduction in the thickness, and therefore, the size of the fragment object 263 is reduced.

In the example shown in the lower diagram of FIG. 38, the player character 201, which is sitting on the fragment object 263, has moved on the terrain object 202 to enter the region 251 of the terrain object formed of the lava material. In this case, as in the fifth example, a portion of the region 251 is changed such that a material is cooled and changed by the fragment object 263 at and near the position where the fragment object 263 has entered to come into contact with the region 251 of the terrain object formed of the lava material for the first time. Specifically, the game system 1 generates an update range including the contact position, and changes materials of voxels of the terrain object in the update range to change a portion of the region 251 of the terrain object.

For example, as in the fifth example, the update range is set in a shape corresponding to the shape that the fragment object 263 has entered the region 251 of the terrain object 202 to come into contact with for the first time, and the lava material of voxels of the terrain object in the update range is changed to the obsidian material. Thereafter, based on the changed material of the voxels, materials of a display mesh and a determination mesh of terrain object of the terrain object are determined. In the lower diagram of FIG. 38, the portion of the region 251 changed to the obsidian material is set as a region 264.

In the sixth example, when the fragment object 263 moves in the region 251, the size of the fragment object 263 is reduced as the lower surface thereof is partially cut away according to movement distance, and in addition, the size of the fragment object 263 is reduced by the scaling described in the fifth example with the passage of time such that the fragment object 263 is melted due to contact with the region 251 formed of the lava material. Specifically, when the fragment object 263 is moved in the region 251 with the player character 201 sitting thereon, the size of the fragment object 263 is reduced as the lower surface thereof is partially cut away and, in addition, the fragment object 263 is subjected to a reduction process by scaling. Specifically, the size of the fragment object 263 is reduced as the lower surface thereof is partially cut away according to movement distance in the region 251 and the fragment object 263 is scaled according to the elapsed time for which the fragment object 263 has been in contact with the region 251. When the size of the fragment object 263 is smaller than a predetermined reference, the fragment object 263 is deleted from the game space, the effect of moving is ended, and the effect of cooling the region 251 formed of the lava material by the fragment object 263 is ended.

Thus, in the sixth example, in the case in which a material of a fragment object is the material that a player character can sit on and is capable of changing a material of another voxel object, the effect of moving on a terrain object and the effect of changing the material of the another voxel object are produced for the fragment object as an in-game effect corresponding to the material, and the size of the fragment object is reduced by scaling according to the elapsed time for which the effect has been produced while the lower surface thereof is partially cut away according to the movement distance over which the effect has been produced. As a result, a player character can be caused to perform an action of removing a fragment object from a terrain object, and a plurality of effects can be produced by consuming the removed object according to a material of the removed object.

Although in the sixth example, a plurality of effects that are the effect of moving on a terrain object and the effect of changing a material are produced for a fragment object, the combination of the plurality of effects is not particularly limited. For example, in the case in which it is assumed that a material of a fragment object is the light stone material, and a player character 201 sits on the fragment object, the effect of moving on a terrain object and the effect of setting a light source at the position of the fragment object can be produced for the fragment object as an in-game effect corresponding to the material.

In addition, the elements that are described above in the first to sixth examples such as an in-game effect obtained using a fragment object, a technique of reducing the size of a fragment object, and a trigger or timing for reducing the size of a fragment object may be combined in any suitable manners. As an example, the elements may be suitably combined for each specialized specification. As another example, the elements may be irregularly replaced therebetween for a specialized specification. In that case, the combination of the elements may be changed with any suitable timing.

In addition, the technique of reducing the size of a fragment object by cutting away a portion thereof may be applied to any surface or portion of the fragment object. For example, in the case in which the size of the fragment object 257 used in the second example is reduced by cutting away a portion thereof, the size of the fragment object 257 may be reduced by cutting away a portion thereof that is in contact with the wire rope 301, based on gliding distance.

In addition, the details of the process executed when an in-game effect is obtained using a fragment object are not particularly limited. For example, when the size of a fragment object is reduced by obtaining the in-game effect, the process may be a process of displaying an effect around the fragment object (e.g., an effect representing consumption of the fragment object). In that case, the game system 1 may provide different effects, depending on different types or consumed amounts of materials set for polygons of a consumed portion of a fragment object.

### [3. Specific Example of Processing in Game System]

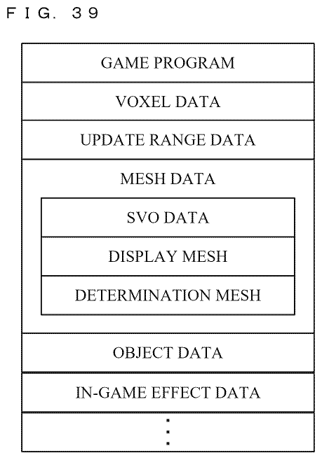

Next, a specific example of information processing in the game system 1 will be described with reference to FIGS. 39 to 41.

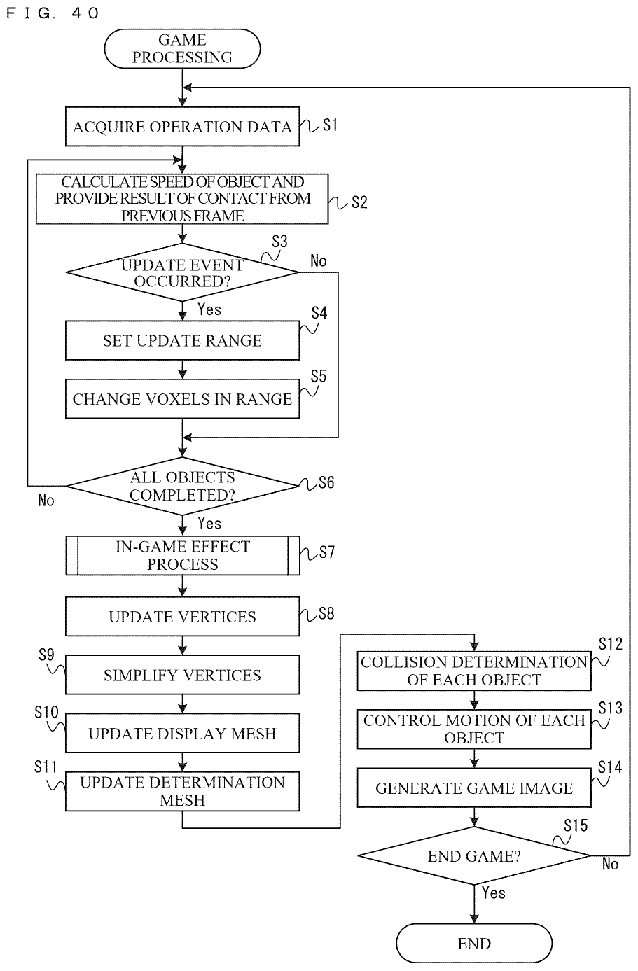

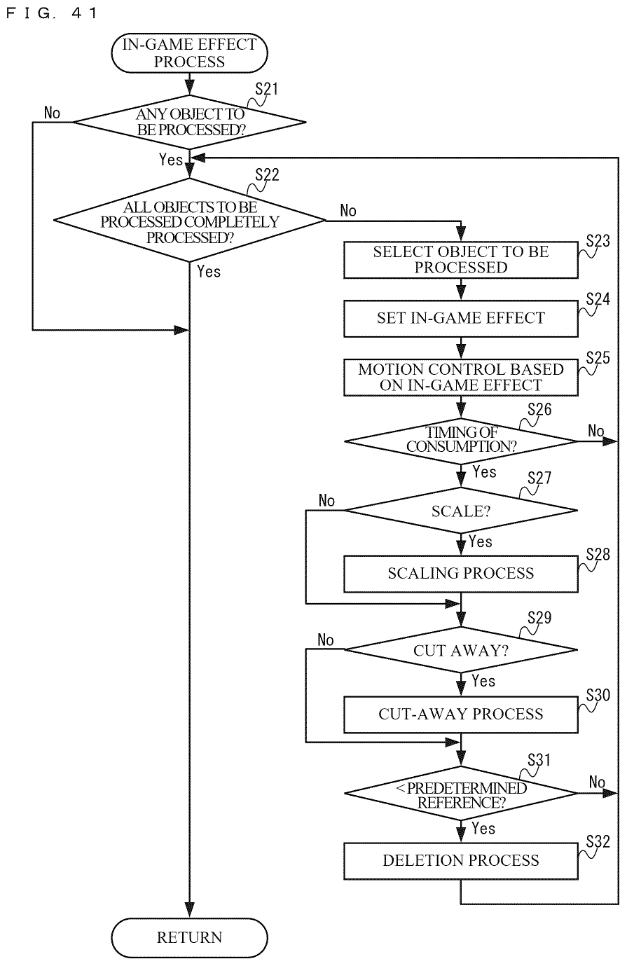

FIG. 39 shows an example of various data used for information processing in the game system 1. The data shown in FIG. 39 are stored in a memory (e.g., the flash memory 84, the DRAM 85, and/or a memory card attached to the slot 23) that is accessible by the main body apparatus 2. As shown in FIG. 39, the game system 1 stores a game program therein. The game program is a program for executing game processing (e.g., game processing shown in FIGS. 40 and 41) in the present example. The game program includes the aforementioned material data (see FIG. 12). In the memory, the aforementioned voxel data (see FIG. 11), update range data, mesh data, object data, in-game effect data, and the like (see FIG. 39).

The update range data is data indicating the aforementioned update range. In the present example, the update range is represented by the aforementioned SDF.

The mesh data includes various data regarding meshes of a voxel object. As shown in FIG. 36, in the present example, the mesh data includes SVO data, display mesh data, and determination mesh data. The SVO data is data in which vertices calculated from the voxel data are held by the aforementioned SVO structure. In the present example, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The object data includes various data regarding objects (e.g., a player character and a virtual object) other than the voxel object. The object data is stored for each object that appears in the game space. The object data includes data indicating, for example, the position, speed, state, etc., of the object.

The in-game effect data is associated with an in-game effect that is obtained by reducing the size of a voxel object (e.g., a fragment object) to reduce the voxel object, and is set, corresponding to a material of the voxel object.

FIG. 40 is a flowchart showing an example of a flow of game processing executed by the game system 1. In addition, FIG. 41 is a subroutine showing an example of an in-game effect process in step S7 of FIG. 40. Execution of the game processing is started in response to the game having been started according to an instruction of the player, during execution of the game program, for example. A processing loop composed of a series of processes in steps S1 to S15 is performed in a cycle of once for each frame.

In the present example, the processor 81 of the main body apparatus 2 executes the game program stored in the game system 1 to execute processes in steps shown in FIGS. 40 and 41. However, in other examples, a portion of the processes in the steps may be executed by a processor (e.g., a dedicated circuit or the like) other than the processor 81. Further, if the game system 1 is communicable with another information processing apparatus (e.g., a server), a portion of the processes in the steps shown in FIGS. 40 and 41 may be executed by the other information processing apparatus. The processes in the steps shown in FIGS. 40 and 41 are merely examples, and the processing order of the steps may be changed, or another process may be executed in addition to (or instead of) the processes in the steps as long as similar results can be obtained.

The processor 81 executes the processes in the steps shown in FIGS. 40 and 41 by using a memory (e.g., the DRAM 85). That is, the processor 81 stores information (in other words, data) obtained in each process step, into the memory, and reads out the information from the memory when using the information for the subsequent process steps.

In FIG. 40, the processor 81 obtains the operation data indicating the user's operation input (step S1), and proceeds to the next step. For example, the processor 81 acquires the operation data output from the respective controllers via the controller communication section 83 and/or the terminals 17 and 21 or the operation data output from the main body apparatus 2 (e.g., the touch panel 13).

Next, the processor 81 designates, as a processing target, an object for which processing has not yet been completed (including a voxel object defined in the specific voxel space) among objects to be processed in the game space, and executes, for the designated object, a process of calculating a speed, and a process of providing (e.g., reflecting) a result of contact between objects in a previous frame (step S2), and proceeds to the next step. The speed of the object is used for calculating the position of the object in the current frame, in the process of step S13 described below. For example, if the designated object is a player character, the speed of the player character is calculated based on the operation data acquired in step S1. If the designated object is an object that is not operated by the user, the speed of the object is calculated based on a rule prescribed in the game program. For example, the speed of the fragment object used by the player character 201 is set to zero if the fragment object is disposed on the terrain object and does not move, is set to the same speed as the player character if the fragment object is held by the player character, and is set to a speed at which the fragment object moves in a direction based on the direction of the player character with a size determined in the above rule if the fragment object has been thrown by a throwing action of the player character. Specifically, the speed of the object is calculated based on a virtual physical calculation including interaction between objects. For example, repulsion due to a collision between objects, interaction such as friction due to contact, falling due to virtual gravity, deceleration due to virtual air resistance, or the like is provided in determination of the speed.

The process of providing the result of contact between objects in the previous frame includes a process of, upon determining in the collision determination (step S12 described below) that objects have come into contact with each other, giving an influence due to the contact, to the objects. Examples of this process are as follows.
A process of, when it is determined that a player character has come into contact with a terrain object of lava in the previous frame, reducing the hit points of the player character
A process of, when it is determined that a player character has pulled out a portion of a terrain object by performing the pull-out action or the like in the previous frame, generating a fragment object (a specific voxel space and voxel data and mesh data thereof)
A process of, when it is determined that a player character has come into contact with a terrain object by performing the punching action or the like in the previous frame, generating a fragment object (a specific voxel space and voxel data and mesh data thereof)

If the state regarding an object has been changed in the process in step S2, the processor 81 updates the corresponding object data stored in the memory regarding the object such that the object data indicates the changed content.

Next, the processor 81 determines whether or not an update event that updates the voxel object has been caused by the object designated in step S2 (step S3). For example, the determination in step S3 is performed based on the result of collision determination (step S11 described below) in the previous frame. As a first example, when it is determined that a player character has pulled out a terrain object by performing the pull-out action or the like in the previous frame, it is determined that an update event in which a portion of the terrain object is deleted has occurred. As a second example, when it is determined that a player character has come into contact with a terrain object by performing the punching action or the like in the previous frame, it is determined that an update event in which a portion of the terrain object is deleted has occurred. If the update event has occurred, the processor 81 proceeds to step S4. If the update event has not occurred, the processor 81 proceeds to step S6.

In step S4, the processor 81 sets, in the game space, an update range in which update of the voxel object is performed, and proceeds to the next step. For example, the specific content (e.g., position, shape, and size) of the update range is associated with each of the types of update events in the game program. In step S4, the update range is set so as to have the content associated with the type of the update event that has been determined in step S3 to occur. In step S4, the processor 81 stores data indicating the set update range, as update range data in the memory.

Next, the processor 81 changes the voxels corresponding to the update range set in step S4, according to the update event (step S5), and proceeds to step S6. For example, in performing deformation such that a voxel object within the update range is deleted or downsized or a voxel object is added within the update range, the processor 81 updates the voxel data stored in the memory so as to change the densities of the voxels corresponding to the update range (see the above [2-2. Update of voxel data]). In addition, in changing the material of the voxel object within the update range, the processor 81 updates the voxel data stored in the memory so as to update at least one of the first material ID, the second material ID, and the material mixing ratio of the voxels corresponding to the update range.

In step S6, the processor 81 determines whether or not all objects that need to be processed (including a voxel object defined by a specific voxel space) have been completely processed in steps S2 to S5. If all of the objects have been completely processed, the processor 81 proceeds to step S7. Otherwise, i.e., if not all of the objects have been completely processed, the processor 81 returns to and repeats step S2.

In step S7, the processor 81 executes an in-game effect process, and proceeds to step S8. The in-game effect process of step S7 will be described below with reference to FIG. 41.

In FIG. 41, the processor 81 determines whether or not there is, in the game space, any object whose size to be reduced so as to produce an in-game effect (step S21). For example, the result of the determination by the processor 81 in step S21 is positive if there is any object for which the in-game effect is to be produced because the player character 201 is holding the object (e.g., the fragment object 256 in the first example), there is any object for which the in-game effect is to be produced by the player character 201 moving or gliding using the object (e.g., the fragment object 257 in the second example, the fragment object 258 in the third example, and the fragment object 263 in the sixth example), there is any object for which the in-game effect is to be produced by the object being disposed in the game space (e.g., the fragment object 261 in the fourth example), or there is any object for which the in-game effect is to be produced so as to change a material of another voxel object (e.g., the fragment object 263 in the fifth and sixth examples). If in the game space there is at least one object for which the in-game effect is to be produced, the processor 81 proceeds to step S22. Otherwise, i.e., if in the game space there is not any object for which the in-game effect is to be produced, the processor 81 ends the subroutine.

In step S22, the processor 81 determines whether or not all objects that need to be processed have been completely processed in steps S23 to S32 described below. If all of the objects to be processed have been completely processed, the processor 81 ends the subroutine. Otherwise, i.e., if not all of the objects to be processed have been completely processed, the processor 81 proceeds to step S23.

In step S23, the processor 81 selects one of objects that have not been completely processed, as an object to be processed, and proceeds to the next step.

Next, the processor 81 sets an in-game effect for the object to be processed that has been selected in step S23 (step S24), and proceeds to the next step. For example, the process of setting an in-game effect is executed using the method described above in [2-7. Process of producing in-game effect by consumption of voxel object], and updates the in-game effect data stored in the memory based on the details of the setting. The process of setting an in-game effect is, for example, as follows.
For the fragment object 256 described in the first example, which is formed of the levitation stone material, the effect of causing a player character 201 that is holding the fragment object 256 to rise in the air in the game space is set.
For the fragment object 257 described in the second example, which is formed of the material that can be held, the effect of causing a player character 201 which is holding the fragment object 257 to move on a predetermined path (the wire rope 301) in the game space is set.
For the fragment object 258 described in the third example, which is formed of a material that a player character can sit on, the effect of causing a player character 201 that is sitting on the fragment object 258 to move on the terrain object 202 in the game space is set.
For the fragment object 261 described in the fourth example, which is formed of the light stone material, the effect of setting a light source at the position of the fragment object 261 in the game space is produced.
For the fragment object 263 described in the fifth example, which is formed of the ice material, the effect of changing a material of another voxel object that has come into contact with the fragment object 263 is produced.
For the fragment object 263 described in the sixth example, which is formed of the ice material, the effect of causing a player character 201 that is sitting on the fragment object 263 to move the terrain object 202 and the effect of changing a material of another voxel object that has come into contact with the fragment object 263 are produced.

Next, the processor 81 performs motion control of the object to be processed that has been selected in step S23, based on the in-game effect set in step S24 (step S25), and proceeds to the next step. For example, the motion control of the object to be processed is performed in accordance with the method described above in [2-7. Process of producing in-game effect by consumption of voxel object] based on the operation data acquired in step S1. Thereafter, in step S25, the processor 81 updates the object data stored in the memory so that the object data contains a content indicating the object after the motion control in step S25. It should be noted that in a single process in step S25, as for a motion (e.g., an action of the object to be processed and/or the player character) that is performed over a plurality of frames, the processor 81 controls each object so as to progress the motion for one frame. As a result, by the process in step S25 being repeatedly executed over a plurality of frames, each object performs a series of motions regarding movement and various actions. In addition, when it is determined by collision determination in step S12 described below that the player character has come into contact with another object, and the player character's action is blocked the another object, the action may be determined, taking into account the blocked state. In addition, in the case in which in the motion control of step S25, the process of generating an update range and changing voxels in the update range is executed, said process may be executed in steps S3 to S5 instead of step S25.

Next, the processor 81 determines whether or not the current time is the timing of reducing the size of the object to be processed that has been selected in step S23 to consume the object (step S26). If the current time is said timing, the processor 81 proceeds to step S27. Otherwise, i.e., if the current time is not said timing, the processor 81 returns to and repeats step S22.

In step S27, the processor 81 determines whether or not to reduce the size of the object to be processed that has been selected in step S23, by a scaling process. If the processor 81 determines to reduce the size of the object to be processed, by the scaling process, the processor proceeds to step S28. Otherwise, i.e., if the processor 81 does not determine to reduce the size of the object to be processed, by the scaling process, the processor 81 proceeds to step S29.

In step S28, the processor 81 reduces the size of the object to be processed that has been selected in step S23, by the scaling process, and proceeds to step S29. For example, the scaling process is executed in accordance with the method described above in [2-7. Process of producing in-game effect by consumption of voxel object], and manages the size of the object after the scaling process (e.g., the reduction ratio with respect to the initial size) using the in-game effect data stored in the memory.

In step S29, the processor 81 determines whether or not to partially cut away the lower surface of the object to be processed that has been selected in step S23. If the processor 81 determines to partially cut away the lower surface, the processor 81 proceeds to step S30. Otherwise, i.e., if the processor 81 does not determine to partially cut away the lower surface, the processor 81 proceeds to step S31.

In step S30, the processor 81 reduces the size of the object to be processed that has been selected in step S23, by partially cutting away the lower surface thereof, and proceeds to step S31. For example, the process of partially cutting away the lower surface is executed in accordance with the method described above in [2-7. Process of producing in-game effect by consumption of voxel object], and manages the size of the object after the cutting process (e.g., the reduction ratio with respect to the initial size) using the in-game effect data stored in the memory.

In step S31, the processor 81 determines whether or not the size of the object to be processed that has been selected in step S23 is smaller than a predetermined reference. If the size of the object to be processed is smaller than the predetermined reference, the processor 81 proceeds to step S32. Otherwise, i.e., if the size of the object to be processed is at least the predetermined reference, the processor 81 returns to and repeats step S22.

In step S32, the processor 81 executes a deletion process, and returns to and repeats step S22. For example, the processor 81 deletes the object to be processed that has been selected in step S23 from the game space, and deletes data stored in the memory and related to the object to be processed (voxel data (specific voxel space data), mesh data, object data, in-game effect data, and the like).

Referring back to FIG. 40, after the in-game effect process in step S7, the processor 81 updates the vertices of the voxel object in the game space (step S8), and proceeds to the next step. For example, if the voxel data has been updated in the process in step S5 or S7, the processor 81 calculates new vertices based on the updated voxel data. The positions of the new vertices are calculated according to the method described in the above [2-3. Calculation of vertices]. In addition, materials of the new vertices are calculated according to the method described in the above [2-4. Determination of material of vertex].

Next, the processor 81 performs simplification for the vertices (step S9), and proceeds to the next step. For example, the processor 81 performs simplification for the vertices updated in the process in step S7, according to the method described in the above [2-5. Simplification of vertices]. Thereafter, the processor 81 updates the SVO data stored in the memory is updated so as to indicate the vertices obtained through the processes in steps S8 and S9. The processes in steps S8 and S9 may not necessarily calculate new vertices for the entirety of the voxel data, and may be performed only for the part in which the content of the voxels has been changed in the process in step S5 or S7.

Next, the processor 81 updates the display mesh of the voxel object, based on the SVO data stored in the memory (step S10), and proceeds to the next step. The positions of the vertices of the display mesh and the materials of the polygons in the display mesh (e.g., the materials set for the vertices of the polygons) are calculated according to the method described in the above [2-6. Generation of mesh] and [2-6-1. Determination of material of display mesh]. In step S10, the processor 81 updates the display mesh data stored in the memory so as to indicate the positions and materials of the vertices of the updated display mesh. The processor 81 may start the process in step S11 and subsequent steps described below without waiting for completion of step S10 to execute these steps in parallel with step S10. In that case, step S10 needs to be completed before start of step S14 described below.

Next, the processor 81 updates the determination mesh of the voxel object, based on the SVO data stored in the memory (step S11), and proceeds to the next step. The positions of the vertices of the determination mesh and the materials of the polygons in the determination mesh (e.g., the materials set for the vertices of the polygons) are calculated according to the method described in the above [2-6. Generation of mesh] and [2-6-2. Determination of material of determination mesh]. In step S11, the processor 81 updates the determination mesh data stored in the memory so as to indicate the positions and materials of the vertices of the updated determination mesh.

In the example shown in FIG. 40, the determination mesh generation process in step S11 is executed for each frame, but the determination mesh generation process may not necessarily be executed for each frame. For example, in the case where the collision determination process in step S12 described below is executed only for a frame that satisfies a predetermined condition, the processor 81 may execute the determination mesh generation process in the frame in which the collision determination is performed. In addition, the processor 81 may execute the determination mesh generation process for voxels in a region, in the game space, where the collision determination in step S12 is performed. For example, in a situation where, in the game space, an object to be subjected to collision determination does not exist around the player character, except for a voxel object (e.g., a situation where only collision determination between the player character and the neighboring voxel object needs to be performed), the processor 81 may execute the determination mesh generation process for voxels within a predetermined range based on the player character.

Next, the processor 81 performs collision determination for each object in the game space, based on the determination mesh data and the object data stored in the memory (step S12), and proceeds to the next step. For example, the processor 81 performs collision determination by using a determination mesh for a voxel object, and using, for an object that is not a voxel object, a determination region having a predetermined shape, which is set for the object. In the present example, the collision determination in step S12 is performed in consideration of the speed calculated in step S2. That is, the processor 81 performs collision determination by using, as the position of each object, the position to which the object moves at the speed.

In the present example, presence/absence of the following contacts is determined by the collision determination in step S12.
Contact of the player character that moves or performs the pull-out action, punching action or the like, with the terrain object
Contact of a fragment object with a player character or other objects

If the result of the collision determination in step S12 is that the objects have come into contact with each other, a process of determining (e.g., generating) the result of the contact of the objects is performed in step S2 in the next frame, or it is determined in step S3 in the next frame that an update event has occurred.

Next, the processor 81 controls the motion of each object in the game space (step S15), and proceeds to the next step. For example, as for the player character, the processor 81 performs a control that causes the player character to move or perform various actions, based on the operation data acquired in step S1. Thereafter, if a predetermined action has occurred, the processor 81 generates a region for collision determination according to the action in the game space. In addition, the processor 81 performs control to cause the fragment object released by the player character's throwing action to move in the direction in which the fragment object has been thrown. It should be noted that in a single process in step S13, as for a motion (e.g., an action of the player character) that is performed over a plurality of frames, the processor 81 controls each object so as to progress the motion for one frame. As a result, by the process in step S13 being repeatedly executed over a plurality of frames, each object performs a series of motions regarding movement and various actions. The position of each object is basically determined to be the position after the object has moved with the speed calculated in step S2. However, in the case where an object is determined to come into contact with another object by the collision determination in step S12 and movement of this object is prevented by the other object, the position of the object may be determined not to be changed. In step S13, the processor 81 updates the object data stored in the memory so as to have the content indicating the object after the control in step S13.

Next, the processor 81 generates a game image (step S14), and proceeds to the next step. For example, the processor 81 generates a game image by performing rendering, based on the virtual camera, for the polygons of the display mesh of the voxel object, and the polygons of objects other than the voxel object. The polygons of the display mesh are rendered by using rendering setting such as textures corresponding to materials set for the polygons, according to the method described in the above [2-6-1. Determination of material of display mesh]. The game image generated in step S14 is outputted to the display device and displayed in a cycle of once for each frame.

Next, the processor 81 determines whether or not to end the game (step S15). For example, if a predetermined operation input to end the game has been performed by the user or if a condition for ending the game is satisfied, the determination result in step S15 is positive. If the processor 81 determines to end the game, the processor 81 ends the flowchart. If the processor 81 does not determine to end the game, the processor returns to and repeats step S1. Thereafter, a series of processes in steps S1 to S15 is repeatedly executed until the processor 81 determines to end the game in step S15.

Thus, in the present example, a player character can be caused to perform an action of removing a fragment object from a terrain object, and the effect that occurs due to consumption of the removed object, depending on a material of the object, can be produced. Therefore, a material in the voxel data can be utilized in a game.

It should be noted that in other examples, an in-game effect may be changed in other ways. As a first example, the size of an in-game effect may be changed according to the remaining size of a fragment object that produces the in-game effect due to a reduction in the size thereof. As a second example, the size of an in-game effect may be changed according to the type of a material of a fragment object that produces the in-game effect due to a reduction in the size thereof. As a third example, the size of an in-game effect may be changed according to the play level or capability of a player character that utilizes a fragment object that produces the in-game effect due to a reduction in the size thereof.

In addition, although in the foregoing description, an example has been described in which a voxel object is specified by generating a three-dimensional mesh based on voxel data set for voxels in a three-dimensional space, a voxel object may be specified based on voxel data set for two-dimensional voxels.

It should be noted that the information processing apparatus 1 may be any suitable apparatus, including handheld game apparatuses, personal digital assistants (PDAs), mobile telephones, smartphones, personal computers, cameras, tablet computers, and the like. In that case, an input apparatus for performing a user operation of moving a player character or the like may not be the left controller 3, the right controller 4, the touch panel 13, or the like, and may be other controllers, a mouse, a touch pad, a touch panel, a trackball, a keyboard, a directional pad, a slide pad, or the like.

In the foregoing, each information process (game process) is performed in the game system 1 by way of example. Alternatively, at least a portion of the process steps may be performed in another apparatus. For example, when the information processing apparatus 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the information processing apparatus 1 executing predetermined programs. Alternatively, all or a portion of the above processes may be performed by a dedicated circuit included in the information processing apparatus 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the information processing apparatus 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is applicable as a game program, game processing method, game system, game apparatus, and the like that can execute a game in which a material is incorporated in (e.g., reflected on) an appearance or a behavior generated in a game, for an object based on voxel data.

What is claimed is:

1. One or more non-transitory computer-readable storage media having stored therein instructions that, when executed, cause one or more processors to perform operations comprising:
generating and updating a first mesh based on first voxel data defined in a virtual space, wherein the first mesh is a mesh of a first voxel object related to the first voxel data, wherein in the first voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material;
controlling a player character in the virtual space based on an operation input, and in response to a first instruction based on an operation input,
causing the player character to perform a first action,
reducing the densities of voxels of the first voxel data related to a first voxel update range set based on a position where the first action has been performed, and
generating second voxel data and a second mesh, wherein, for each voxel, the density and the material are set in the second voxel data, and the material of the voxel is set, in the second voxel data, to the same material as one of materials of voxels of the first voxel data or the first mesh that is determined based on a positional relationship with respect to the position where the first action has been performed, and wherein the second mesh is a mesh of a second voxel object related to the second voxel data, vertex coordinates of the mesh of the second voxel object are determined based on at least the density, and a material of the mesh of the second voxel object is determined based on the material of the second voxel data;
when the material of the second voxel data is a first material, generating a first in-game effect related to the first material for the second voxel object, and reducing a size of the second voxel object according to game progression; and
rendering the virtual space including the first mesh and the second mesh.

2. The one or more non-transitory computer-readable storage media according to claim 1, wherein
the first voxel data is defined in a first voxel space,
the second voxel data is defined in a second voxel space, and
the operations further comprise:
reducing the size of the second voxel object by reducing a size in the virtual space of the second voxel space.

3. The one or more non-transitory computer-readable storage media according to claim 1, wherein
the operations further comprise:
setting a second voxel update range at a position in the virtual space based on a position of the first voxel object, and reducing the size of the second voxel object by reducing the densities of voxels in the second voxel data related to the second voxel update range.

4. The one or more non-transitory computer-readable storage media according to claim 1, wherein
the operations further comprise:
reducing the size of the second voxel object with the passage of time during which the first in-game effect is produced.

5. The one or more non-transitory computer-readable storage media according to claim 1, wherein
the operations further comprise:
reducing the size of the second voxel object each time the first in-game effect is produced.

6. The one or more non-transitory computer-readable storage media according to claim 4, wherein
the first voxel data is defined in a first voxel space,
the second voxel data is defined in a second voxel space, and
the operations further comprise:
reducing the size of the second voxel object by reducing a size in the virtual space of the second voxel space.

7. The one or more non-transitory computer-readable storage media according to claim 4, wherein
the operations further comprise:
setting a second voxel update range at a position in the virtual space based on a position of the first voxel object, and reducing the size of the second voxel object by reducing the densities of voxels in the second voxel data related to the second voxel update range.

8. The one or more non-transitory computer-readable storage media according to claim 1, wherein
the operations further comprise:
when the size of the second voxel object is smaller than a reference, deleting the second voxel object and ending the first in-game effect.

9. The one or more non-transitory computer-readable storage media according to claim 1, wherein
the operations further comprise:
causing the player character to perform an action of holding the second voxel object and an action of releasing the second voxel object according to a second instruction based on an operation input; and
when the player character is holding the second voxel object, producing the first in-game effect.

10. The one or more non-transitory computer-readable storage media according to claim 9, wherein
the operations further comprise:
controlling movement of the player character based on virtual gravity toward a downward direction in the virtual space; and
when the player character is holding the second voxel object, causing the player character to move in an upward direction in the virtual space as the first in-game effect.

11. The one or more non-transitory computer-readable storage media according to claim 9, wherein
the operations further comprise:
when the player character is holding the second voxel object, causing the player character to move on a path set in the virtual space as the first in-game effect.

12. The one or more non-transitory computer-readable storage media according to claim 9, wherein
the operations further comprise:
when the player character is sitting on the second voxel object, causing the player character to move on the first object, based on an operation input, as the first in-game effect.

13. The one or more non-transitory computer-readable storage media according to claim 9, wherein
the material has a hardness depending on the type of the material, and
the operations further comprise:
causing the player character to move along with the second voxel object, and reducing the size of the second voxel object based on the hardness of the material of the second voxel object and a movement distance of the second voxel object, as the first in-game effect.

14. The one or more non-transitory computer-readable storage media according to claim 1, wherein
the operations further comprise:
setting a light source at a position of the second voxel object in the virtual space as the first in-game effect.

15. The one or more non-transitory computer-readable storage media according to claim 1, wherein
the operations further comprise:
when materials of voxels in the first voxel data related to a third voxel update range including a position of the second voxel object are a second material, changing the materials to a third material.

16. The one or more non-transitory computer-readable storage media according to claim 1, wherein
the first mesh includes a display mesh used for rendering and a determination mesh used for collision determination,
a material of the display mesh is set by setting at least one material for each polygon of the mesh, based on the materials of the voxels around each vertex of the polygon,
a material of the determination mesh is set by setting a material for each polygon of the mesh, based on the materials of the voxels around each vertex of the polygon, and
the operations further comprise:
setting the same material as that which is set for a polygon at a collision position, as the material of the second voxel data, based on collision determination between a collision shape set based on the position where the first action has been performed and the determination mesh of the first mesh; and
rendering the first mesh by rendering the display mesh based on vertex coordinates of the display mesh and a texture associated with the material of each polygon of the display mesh.

17. A game processing method, comprising:
generating and updating a first mesh based on first voxel data defined in a virtual space, wherein the first mesh is a mesh of a first voxel object related to the first voxel data, wherein in the first voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material;
controlling a player character in the virtual space based on an operation input, and in response to a first instruction based on an operation input,
causing the player character to perform a first action,
reducing the densities of voxels of the first voxel data related to a first voxel update range set based on a position where the first action has been performed, and
generating second voxel data and a second mesh, wherein, for each voxel, the density and the material are set in the second voxel data, and the material of the voxel is set, in the second voxel data, to the same material as one of materials of voxels of the first voxel data or the first mesh that is determined based on a positional relationship with respect to the position where the first action has been performed, and wherein the second mesh is a mesh of a second voxel object related to the second voxel data, vertex coordinates of the mesh of the second voxel object are determined based on at least the density, and a material of the mesh of the second voxel object is determined based on the material of the second voxel data;
when the material of the second voxel data is a first material, generating a first in-game effect related to the first material for the second voxel object, and reducing a size of the second voxel object according to game progression; and
rendering the virtual space including the first mesh and the second mesh.

18. The game processing method according to claim 17, wherein
the first voxel data is defined in a first voxel space,
the second voxel data is defined in a second voxel space, and
the method further comprises:
reducing the size of the second voxel object by reducing a size in the virtual space of the second voxel space.

19. The game processing method according to claim 17, further comprising:
setting a second voxel update range at a position in the virtual space based on a position of the first voxel object, and reducing the size of the second voxel object by reducing the densities of voxels in the second voxel data related to the second voxel update range.

20. The game processing method according to claim 17, further comprising:
reducing the size of the second voxel object with the passage of time during which the first in-game effect is produced.

21. The game processing method according to claim 17, further comprising:
reducing the size of the second voxel object each time the first in-game effect is produced.

22. The game processing method according to claim 20, wherein
the first voxel data is defined in a first voxel space,
the second voxel data is defined in a second voxel space, and
the method further comprises:
reducing the size of the second voxel object by reducing a size in the virtual space of the second voxel space.

23. The game processing method according to claim 20, further comprising:
setting a second voxel update range at a position in the virtual space based on a position of the first voxel object, and reducing the size of the second voxel object by reducing the densities of voxels in the second voxel data related to the second voxel update range.

24. The game processing method according to claim 17, further comprising:
when the size of the second voxel object is smaller than a reference, deleting the second voxel object and ending the first in-game effect.

25. The game processing method according to claim 17, further comprising:
causing the player character to perform an action of holding the second voxel object and an action of releasing the second voxel object according to a second instruction based on an operation input; and
when the player character is holding the second voxel object, producing the first in-game effect.

26. The game processing method according to claim 25, further comprising:
controlling movement of the player character based on virtual gravity toward a downward direction in the virtual space; and
when the player character is holding the second voxel object, causing the player character to move in an upward direction in the virtual space as the first in-game effect.

27. The game processing method according to claim 25, further comprising:
when the player character is holding the second voxel object, causing the player character to move on a path set in the virtual space as the first in-game effect.

28. The game processing method according to claim 25, further comprising:
when the player character is sitting on the second voxel object, causing the player character to move on the first object, based on an operation input, as the first in-game effect.

29. The game processing method according to claim 25, wherein
the material has a hardness depending on the type of the material, and
the method further comprises:
causing the player character to move along with the second voxel object, and reducing the size of the second voxel object based on the hardness of the material of the second voxel object and a movement distance of the second voxel object, as the first in-game effect.

30. The game processing method according to claim 17, further comprising:
setting a light source at a position of the second voxel object in the virtual space as the first in-game effect.

31. The game processing method according to claim 17, further comprising:
when materials of voxels in the first voxel data related to a third voxel update range including a position of the second voxel object are a second material, changing the materials to a third material.

32. The game processing method according to claim 17, wherein
the first mesh includes a display mesh used for rendering and a determination mesh used for collision determination,
a material of the display mesh is set by setting at least one material for each polygon of the mesh, based on the materials of the voxels around each vertex of the polygon,
a material of the determination mesh is set by setting a material for each polygon of the mesh, based on the materials of the voxels around each vertex of the polygon, and
the method further comprises:
setting the same material as that which is set for a polygon at a collision position, as the material of the second voxel data, based on collision determination between a collision shape set based on the position where the first action has been performed and the determination mesh of the first mesh; and
rendering the first mesh by rendering the display mesh based on vertex coordinates of the display mesh and a texture associated with the material of each polygon of the display mesh.

33. A game system comprising:
one or more processors; and
one or more memories storing instructions executable by the one or more processors to perform operations comprising:
generating and updating a first mesh based on first voxel data defined in a virtual space, wherein the first mesh is a mesh of a first voxel object related to the first voxel data, wherein in the first voxel data, for each of a plurality of voxels, at least a density indicating the degree of virtual occupation of a content in a space defined by the voxel, and a material indicating the type of the content, are set, and wherein vertex coordinates of the mesh are determined based on at least the density, and a material of the mesh is determined based on at least the material;
controlling a player character in the virtual space based on an operation input, and in response to a first instruction based on an operation input,
causing the player character to perform a first action,
reducing the densities of voxels of the first voxel data related to a first voxel update range set based on a position where the first action has been performed, and generating second voxel data and a second mesh, wherein, for each voxel,
the density and the material are set in the second voxel data, and the material of the voxel is set, in the second voxel data, to the same material as one of materials of voxels of the first voxel data or the first mesh that is determined based on a positional relationship with respect to the position where the first action has been performed, and wherein the second mesh is a mesh of a second voxel object related to the second voxel data, vertex coordinates of the mesh of the second voxel object are determined based on at least the density, and a material of the mesh of the second voxel object is determined based on the material of the second voxel data;
when the material of the second voxel data is a first material, generating a first in-game effect related to the first material for the second voxel object, and reducing a size of the second voxel object according to game progression; and
rendering the virtual space including the first mesh and the second mesh.

34. The game processing system according to claim 33, wherein
the first voxel data is defined in a first voxel space,
the second voxel data is defined in a second voxel space, and
the operations further comprise:
reducing the size of the second voxel object by reducing a size in the virtual space of the second voxel space.

35. The game processing system according to claim 33, wherein
the operations further comprise:
setting a second voxel update range at a position in the virtual space based on a position of the first voxel object, and reducing the size of the second voxel object by reducing the densities of voxels in the second voxel data related to the second voxel update range.

36. The game processing system according to claim 33, wherein
the operations further comprise:
reducing the size of the second voxel object with the passage of time during which the first in-game effect is produced.

37. The game processing system according to claim 33, wherein
the operations further comprise:
reducing the size of the second voxel object each time the first in-game effect is produced.
